(19) United States
(12) Patent Application Publication
(10) Pub. No.: US 2025/0066556 A1
(43) Pub. Date: Feb. 27, 2025

(54) METHANOL EXPLOSION OF CELLULOSIC FIBERS AND THEIR USES

(71) Applicants: James CARUTHERS, West Lafayette, IN (US); PURDUE RESEARCH FOUNDATION, West Lafayette, IN (US)

(72) Inventor: James CARUTHERS, West Lafayette, IN (US)

(21) Appl. No.: 18/789,050

(22) Filed: Jul. 30, 2024

Related U.S. Application Data
(63) Continuation-in-part of application No. PCT/US2023/060905, filed on Jan. 19, 2023.
(63) Continuation-in-part of application No. PCT/US2023/060900, filed on Jan. 19, 2023.
(63) Continuation-in-part of application No. PCT/US2023/060901, filed on Jan. 19, 2023.
(63) Continuation-in-part of application No. PCT/US2023/060903, filed on Jan. 19, 2023.
(60) Provisional application No. 63/304,724, filed on Jan. 31, 2022.
(60) Provisional application No. 63/304,719, filed on Jan. 31, 2022.
(60) Provisional application No. 63/304,722, filed on Jan. 31, 2022.
(60) Provisional application No. 63/304,718, filed on Jan. 31, 2022.

(51) Int. Cl. C08H 7/00; B27N 3/00; B27N 3/04; C08K 7/02

(52) U.S. Cl. CPC C08H 6/00; B27N 3/002; C08K 7/02; B27N 3/04

(57) ABSTRACT

This disclosure relates generally to chemical engineering, and, more specifically, to an improved method and apparatus for recovering lignin from biomass, including using organic solvents, such as methanol, to explosively separate lignin from cellulosic materials, and the harvesting of all of the resulting products. Additionally, the present technology relates to improved uses for the harvested products, including composite board and resin binder systems.

### CROSS-REFERENCE TO RELATED APPLICATIONS

This application is a continuation-in-part of each of PCT/US2023/060905, filed 19 Jan. 2023, PCT/US2023/060900, filed 19 Jan. 2023, PCT/US2023/060901, filed 19 Jan. 2023, and PCT/US2023/060903, filed 19 Jan. 2023, and claims the benefit of each of U.S. Provisional Application Nos. 63/304,724, filed 31 Jan. 2022, 63/304,719, filed 31 Jan. 2022, 63/304,722, filed 31 Jan. 2022, and 63/304,718, filed 31 Jan. 2022, all of which are hereby incorporated by reference in their entirety.

### FIELD

This disclosure relates generally to chemical engineering, and, more specifically, to a method and apparatus for using organic solvents, such as methanol, to explosively separate, clean, free, and depolymerize lignin from cellulosic materials and the harvesting of both. Additionally, the present technology relates generally to chemistry and chemical engineering and, more particularly, improved end use products, such as composite board and resin binder systems, as well as methods of manufacturing the same.

### BACKGROUND

This section introduces aspects that may help facilitate a better understanding of the disclosure. Accordingly, these statements are to be read in this light and are not to be understood as admissions about what is or is not prior art.

Lignin is the most abundant natural aromatic polymer. Lignin has a high storage capacity for phenolic compounds, and as such is a potential source for polymers and biomaterials. However, access to those polymers and biomaterials is difficult, as lignin is both complex and not very reactive.

One method of accessing the locked-in polymers and biomaterials is through depolymerization of the lignin. Steam has been used to explosively separate lignin from biomass fibers. Steam separation is advantageous because water is cheap and plentiful. However, steam explosion of biomass requires a fairly great amount of heat and also requires a nickel catalyst, which poses an initial expense as well as a back-end removal expense. Thus, there is a need for a lignin/cellulosic material separation process that requires less heat input and can be performed without the need of a catalyst. The present novel technology addresses this need.

### BRIEF SUMMARY OF THE DISCLOSURE

A lignin separation and depolymerization assembly, including a soaking tank, an intake port operationally connected to the soaking tank, a high-pressure vapor explosion tank connected in fluidic communication with the soaking tank, and a knockout tank connected in fluidic communication with the high-pressure vapor explosion tank. The assembly further includes a high-pressure reactor vessel operationally connected to the high-pressure vapor explosion tank, at least one input port operationally connected to the high-pressure vessel, a filter press operationally connected to the high-pressure reactor vessel, a flash separator operationally connected to the filter press, a settling vessel operationally connected to the flash separator, and a dryer operationally connected to the filter press. The assembly also includes a liquid-liquid extraction vessel having an outlet port, an inlet port, and wherein the liquid-liquid extraction vessel is operationally connected to the settling vessel and a membrane separator operationally connected to the liquid-liquid extraction vessel, wherein the membrane separator both receives material from the liquid-liquid extraction vessel and supplies material to the liquid-liquid extraction vessel.

A method of preparing a composite board, including soaking a first quantity of biomass fibers in methanol to yield a second quantity of methanol infused biomass fibers, placing the second quantity of methanol infused biomass fibers into a first pressure vessel to increase pressure therein, rapidly reducing pressure within the pressure vessel to yield a third quantity of methanol exploded biomass fibers, and placing the third quantity of methanol exploded biomass fibers into a second pressure vessel. The method further includes introducing methanol, hydrogen gas, nitrogen gas, and acid into the second pressure vessel to define a first admixture, heating the first admixture under increased pressure to yield a quantity of unpurified depolymerized lignin, mixing the quantity of unpurified depolymerized lignin with predetermined quantities of fiber, curing agent, paraffin wax, glyoxal, and dispersant to define a second admixture, and bonding the second admixture with cardboard to yield a formaldehyde-free composite board. The composite board exhibits no more than four percent swelling upon exposure to water, has a modulus of at least 30 kpsia, has a tensile strength of at least 70 psia, and returns to its original thickness after forty-eight hours of drying following a twenty-four hour immersion in water.

A formaldehyde-free fiber-based composite board can be produced as described above, wherein the board includes a fiber portion with a weight percentage of 80-95% and a resin portion with a weight percentage of 5-20%. The resin portion further includes a resin cure package and a wax-based surface modification package. The resin cure package defines a mixture of a catalytically depolymerized product of a fiber-based lignin, wherein the catalytically depolymerized product includes at least one compound selected from the group consisting of:

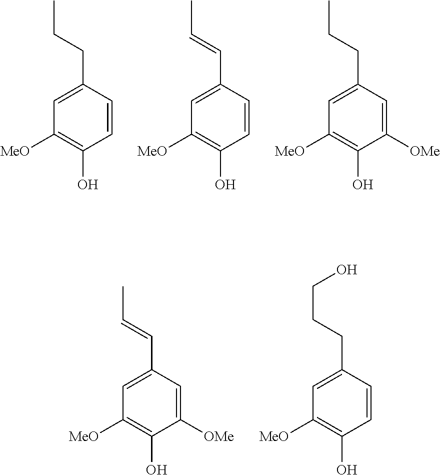

The wax-based surface modification package includes at least one wax material with a formula of CₙH₂ₙ₊₂, wherein n is between 15 and 40. The fiber is typically a rice-straw-based fiber, where other components of the rice-straw mixture may likewise be relevant.

The mixture of the resin cure package typically also includes at least one dialdehyde with a formula of OHC(CH₂)nCHO, wherein n is between 0 and 6. The mixture of the resin cure package typically incudes an anhydride, and that anhydride is typically maleic anhydride. The mixture of the resin cure package may also include a polyamide-epichlorohydrin as a crosslinking agent. The mixture of the resin cure package typically has a pH value of 6.5-7.5.

A method of reducing phenol-formaldehyde in a resin and producing laminates therefrom, including the steps of extracting eugenol from a biomass source, mixing the extracted eugenol with a first quantity of curing agent and a second quantity of water and a third quantity of MeOH solvent in the presence of a KOH catalyst to yield a first admixture, and heating the first admixture to yield a precook admixture. The method further includes adding urea and a crosslinking agent to the precook admixture, adding additional KOH to the precook admixture to yield a second admixture, and heating the second admixture to yield a resin product, wherein the resin product has replaced at least about a third of the phenol-formaldehyde with eugenol-based resin. Next, the method includes brushing resin product onto respective sheets of paper to yield respective sheets of impregnated paper, drying the respective sheets of impregnated paper to yield respective sheets of dried impregnated paper, stacking respective sheets of dried impregnated paper to yield a multiple-sheet laminate stack, and hot-pressing the multiple-sheet laminate stack to yield a cured multiple-sheet laminate.

### BRIEF DESCRIPTION OF THE FIGURES

FIG. 1 is a process flowsheet for production of clean depolymerized lignin and clean cellulose from biomass.

FIG. 2A schematically illustrates the molecular structure of DHE and DMPP.

FIG. 2B schematically illustrates the molecular structure of a binding agent.

FIG. 2C schematically illustrates the molecular structure of a glyoxal.

FIG. 2D schematically illustrates the molecular structure of a paraffin wax.

FIG. 2E schematically illustrates the molecular structure of an SMA resin.

FIG. 3 graphically illustrates the relationship between time after soaking and percent thickness change for various composite board compostions.

### DETAILED DESCRIPTION OF THE DISCLOSURE

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended.

### Methanol Explosion of Cellulosic Fibers

The present novel technology relates to a process for the explosive separation of lignin from cellulosic material using an organic solvent, such as methanol; the depolymerization of the so-separated lignin; and the extraction of clean lignin from the depolymerization yield.

First, a quantity of biomass feedstock, such as wood chips and/or rice straw, are placed in a tank and soaked in an organic solvent. In this example, the feedstock is soaked in methanol, as methanol has a relatively low boiling point (as compared to water). The fibers may be soaked for a predetermined amount of time at room temperature, or at some elevated temperature below the solvent boiling point to speed the kinetics of the soaking process.

The soaked fibers are then moved to a high-pressure tank and additional solvent is added, wherein the pressure is increased and the mixture is superheated; the increased pressure is sufficiently great such that the solvent remains in liquid form when superheated. In some embodiments, the additional solvent is preheated before introduction into the high-pressure tank.

The pressure within the tank is then rapidly reduced, such that the solvent rapidly boils. The solvent soaked within the now-swelled fibers rapidly boils and explodes the fibers. The escaping evolved solvent vapor is collected in a knockout tank fluidically connected to the high-pressure tank, condensed back into a liquid state, and recycled for reuse.

While the process has similarities to known methods of steam explosion of fibers, the novel process enjoys the advantages of not requiring the removal of water for downstream processing. Further, the organic solvent may be chosen for being more effective in swelling natural fibers (like, for example, methanol). Also, the organic solvent may be selected for having a boiling point lower than that of water, so that similar pressures that drive the explosion process can be achieved at lower temperatures with lower associated energy costs.

Next, the separated lignin is depolymerized. The vapor-exploded fibers with solvent are placed in a high-pressure reactor vessel, which may or may not be the same vessel as the vapor explosion unit described above. Additional ingredients such as catalysts, hydrogen, nitrogen, and/or acid are added to the reactor, which is then heated to temperatures that are super-critical and thus generate high pressures. The super-critical conditions with their attendant high temperatures increase the rate of the lignin depolymerization reaction.

Methanol is the solvent used in the current example. Methanol is attractive because it is readily available, readily swells the fibers, has a low boiling compared to other alcohols but remains a liquid with a relatively low vapor pressure, and is one of the components in the composite board resin system that has been developed using the depolymerized lignin, thereby alleviating the need to fully remove the methanol. However, other solvents may also be useful, where the associated process would be similar with different temperatures and pressures required for both the vapor-explosion and lignin depolymerization reaction.

The depolymerization reaction is most commonly done using a metal catalyst, such as supported nickel. However, lignin depolymerization may also be achieved at super-critical temperatures using just high-pressure hydrogen without any metal catalyst. This removes the cost of catalyst preparation as well as the cost of recovery of the catalyst from the reaction products.

Once the lignin depolymerization reaction is complete, a filter press or the like is used to separate the lignin-free fibers from the solvent phase containing the depolymerized lignin. Any remaining solvent in the fibers is removed by drying, where the solvent is then recaptured and returned to the process. The liquid phase from the filter press is then put into a flash evaporator and/or a distillation unit to remove some, but not necessarily all, of the solvent thereby concentrating the depolymerized lignin and any other components in the liquid phase. Solvent may be recovered and recycled back to the process.

The resulting brown liquor contains the depolymerized lignin as well as other components, such as sugars, hemi-cellulose, small amounts of small cellulose fibers that made it past the filter press, some silica and other inorganic material, and the like. Any remaining cellulose fibers and inorganic particulates like silica may be removed in a settling tank or by mild centrifugation.

The above methodology may be applied to a variety of agricultural and forestry sources of biomass, including wheat straw, corn stover, sugar cane bagasse, and the like. The only real requirement is that the biomass have a significant amount of lignin.

It is generally desirable to remove the hemi-cellulose and sugars from the brown liquor. An aqueous salt solution with sufficient molarity forms a two-phase mixture at room temperature with organic solvents (such as, in this case 1 M NaCl in methanol at room temperature to yield a two-phase mixture). The sugars and hemi-cellulose are primarily in the aqueous phase, while the depolymerized lignin remains primarily in the organic phase. Thus, liquid-liquid extraction be employed to separate the sugars and hemi-cellulose from the brown liquor, resulting in clean depolymerized lignin.

The sugars and hemi-cellulose are then separated from the salt solution using membrane technology, where the aqueous salt solution is then recycled to the process. The sugars and hemi-cellulose are a product of the process in addition to the clean depolymerized lignin and the clean cellulose fibers.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

Additional embodiments of the present disclosure include:
Embodiment 1) A lignin separation and depolymerization apparatus, comprising:
   a first modular portion, further comprising:
      a soaking tank;
      an intake port operationally connected to the soaking tank;
      a high-pressure vapor explosion tank connected in fluidic communication with the soaking tank; and
      a knockout tank connected in fluidic communication with the high-pressure vapor explosion tank;
   a second modular portion operationally connected to the first modular portion, further comprising:
      a high-pressure reactor vessel;
      at least one input port operationally connected to the high-pressure vessel;
      a filter press operationally connected to the high-pressure reactor vessel;
      a flash separator operationally connected to the filter press;
      a settling vessel operationally connected to the flash separator; and
      a dryer operationally connected to the filter press; and
   a third modular portion operationally connected to the second modular portion, further comprising:
      a liquid-liquid extraction vessel having an outlet port and an inlet port;
      a membrane separator operationally connected to the liquid-liquid extraction vessel, wherein the membrane separator both receives material from the liquid-liquid extraction vessel and supplies material to the liquid-liquid extraction vessel.
Embodiment 2) The lignin separation and depolymerization apparatus of embodiment 1 wherein the liquid-liquid extraction vessel is operationally connected to the settling vessel; and wherein the high-pressure reactor vessel is operationally connected to the high-pressure vapor explosion tank.
Embodiment 3) The lignin separation and depolymerization apparatus of embodiment 1 wherein and organic solvent fills the soaking tank.
Embodiment 4) The lignin separation and depolymerization apparatus of embodiment 3 wherein the organic solvent has a boiling point below 100 degrees Celsius at atmospheric pressure.
Embodiment 5) The lignin separation and depolymerization apparatus of embodiment 4 wherein the organic solvent is methanol.
Embodiment 6) The lignin separation and depolymerization apparatus of embodiment 1 wherein the settling vessel is a centrifuge.
Embodiment 7) A lignin separation and depolymerization assembly, comprising:
   a soaking tank;
   an intake port operationally connected to the soaking tank;
   a high-pressure vapor explosion tank connected in fluidic communication with the soaking tank; and
   a knockout tank connected in fluidic communication with the high-pressure vapor explosion tank;
   a high-pressure reactor vessel operationally connected to the high-pressure vapor explosion tank;
   at least one input port operationally connected to the high-pressure vessel;
   a filter press operationally connected to the high-pressure reactor vessel;
   a flash separator operationally connected to the filter press;
   a settling vessel operationally connected to the flash separator; and
   a dryer operationally connected to the filter press; and
   a liquid-liquid extraction vessel having an outlet port, an inlet port, and wherein the liquid-liquid extraction vessel is operationally connected to the settling vessel; and
   a membrane separator operationally connected to the liquid-liquid extraction vessel, wherein the membrane separator both receives material from the liquid-liquid extraction vessel and supplies material to the liquid-liquid extraction vessel.
Embodiment 8) The lignin separation and depolymerization assembly of embodiment 7, wherein the soaking tank is filled with methanol.

### Methods for Making Composite Board from Methanol Exploded Depolymerized Lignin and Composite Board Made of the Same

The present novel technology relates to a process for the explosive separation of lignin from cellulosic material using an organic solvent, such as methanol; the depolymerization of the so-separated lignin; and the extraction of clean lignin from the depolymerization yield.

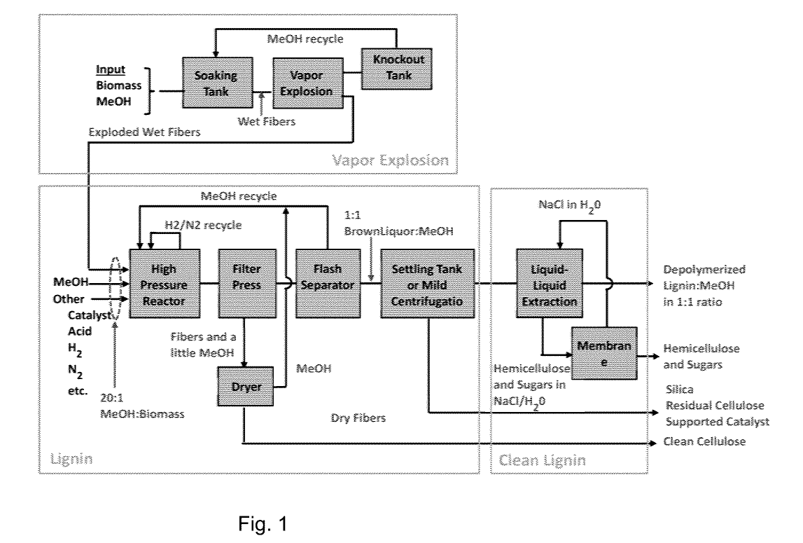

A process has been developed for the production of depolymerized lignin from various sources of biomass. The process flowsheet is given in FIG. 1. The process can produce both (i) clean cellulose that has the lignin removed and (ii) clean, depolymerized lignin where the sugars and hemicellulose components have been removed. Novel features of the technology include:
1. Vapor explosion of biomass. Steam explosion of biomass fibers is well known. However, the use of a solvent other than water is novel. The use of an organic solvent such as methanol provides a number of significant advantages. First, water does not have to be removed from the product with an associated energy cost for the subsequent depolymerization reaction step which uses an organic solvent. Further, the boiling point of the organic solvent can be significantly lower than that of water, such that the super-heated conditions required for vapor explosion can be achieved at lower temperature and hence at a lower energy cost. Finally, there is a higher uptake of specific organic solvents, in this example methanol, by biomass so that the subsequent vapor explosion is more effective.
2. Catalyst-free lignin depolymerization. The current technology for depolymerization of biomass employs a catalyst, typically supported nickel. The instant novel technology performs the reaction at supercritical conditions under a hydrogen atmosphere without the need for a metal catalyst, thus, eliminating the cost of the catalyst as well as the need (with associated cost) to remove the catalyst from the final product.
3. Clean lignin production. After the depolymerization reaction, the cellulose fibers are removed. The depolymerized lignin product also contains sugars and hemicellulose which may not be desirable in some uses of the depolymerized lignin. While liquid-liquid extraction is well-known in the chemical industry, no process has been developed where saline is used to extract the hemi-cellulose and sugars from a depolymerized lignin mixture.

The process technology described herein uses biomass feedstock (in this example wood chips and rice straw) as the lignin source. However, the instant novel technology also works with a variety of agricultural and forestry sources of biomass, including wheat straw, corn stover, sugar cane bagasse, combinations thereof, and the like. The only real requirement is that the biomass have a significant amount of lignin.

A description of the various components of the technology follows below.

### Vapor Explosion

Referring to the Vapor Explosion sub-box in FIG. 1, the process may be envisioned as involving three units:
1. A tank where the fibers are soaked in the solvent, where this may be at room temperature (above room temperature) or the process can be accelerated by soaking at an elevated temperature that is below the boiling temperature of the solvent.
2. A high-pressure tank where additional solvent is injected when the tank has been loaded with the soaked fibers containing solvent. The pressure in the tank is raised such that the fiber-solvent mixture remains in the liquid phase as the mixture is super-heated. The heating process can be efficiently accelerated if the additional solvent is heated prior to injection into the high-pressure tank. Once the fiber-solvent mixture is at a temperature well above the boiling point of the solvent at atmospheric pressure (and thus at elevated pressure), the pressure in the tank is quickly reduced and the solvent rapidly boils. The solvent that has swelled the fibers also boils thereby exploding the fibers.
3. The escaping vapor is captured in a knockout tank, where it is condensed back into a liquid at atmospheric pressure and recycled back into the soaking tank.

This process is similar to that used for steam explosion of fibers, but has the advantages that (i) water is not present in any appreciable quantity and thus does not need to be removed for downstream processing, (ii) some organic solvents like methanol are more effective in swelling natural fibers and (iii) the boiling point of many organic solvents is lower than that of water so that similar pressures that drive the explosion process can be achieved at lower temperatures with associated lower energy costs.

### Lignin Depolymerization

The vapor-exploded fibers with solvent are then put into the high-pressure reactor as shown in the Lignin Depolymerization sub-box in FIG. 1. The high-pressure reactor may be the same unit as the vapor explosion unit described above, where the decision to use one or two reactors may depend upon such factors as (i) increased cost of two reactors, (ii) the time and energy required to heat the depolymerization reactor from sub-critical conditions, needed for vapor explosion, to the super-critical conditions needed for lignin depolymerization, or simply (iii) throughput demand. Additional ingredients such as catalysts, hydrogen, nitrogen, and acid may be added to the reactor, which is then heated to temperatures that are super-critical and thus generate high pressures. The super-critical conditions are desirable, because high temperatures increase the rate of the lignin depolymerization reaction.

Methanol is the solvent used in the current example, although any convenient organic solvent may be selected. Methanol is a good choice for the solvent because it (i) readily swells the fibers, (ii) is low boiling compared to other alcohols but is still a liquid with a relatively low vapor pressure, (iii) is readily available, and (iv) is one of the components in the composite board resin system that has been developed using the depolymerized lignin, thereby alleviating the need to fully remove the methanol. However, any other organic solvent may also be useful, where the associated process would be similar with different temperatures and pressures required for both the vapor-explosion and lignin depolymerization reaction as tailored to the boiling point of the selected organic solvent.

The depolymerization reaction is most commonly accomplished using a metal catalyst, typically supported nickel. However, lignin depolymerization can also be achieved at super-critical temperatures using just high-pressure hydrogen absent metal catalyst. This removes the cost of catalyst preparation as well as the cost of recovery of the catalyst from the reaction products.

Once the lignin depolymerization reaction is complete, a filter press or the like is used to separate the lignin free fibers from the solvent phase containing the depolymerized lignin. Any remaining solvent in the fibers is removed by drying, where the solvent is then recaptured and reintroduced into the process. The liquid phase from the filter press is then put into a flash evaporator and/or a distillation unit to remove some, but not necessarily all, of the solvent thereby concentrating the depolymerized lignin and any other components in the liquid phase. The solvent is recycled back to the process.

The resulting brown liquor contains the depolymerized lignin as well as other components such as sugars, hemi-cellulose, small amounts of small cellulose fibers that made it past the filter press, as well as silica and other inorganic material. Any remaining cellulose fibers and inorganic particulates like silica are removed in a settling tank or by mild centrifugation.

### Liquid-Liquid Extraction for Production of Clean Lignin

In some embodiments it is desirable to remove the hemi-cellulose and sugars from the brown liquor, where the process needed for the removal of these components from the brown liquor is shown in the Clean Lignin sub-box in FIG. 1.

An aqueous salt solution with sufficient molarity forms a two-phase mixture at room temperature with organic solvents (for example, 1 M NaCl in methanol at room temperature yields a two-phase mixture). The sugars and hemi-cellulose are primarily in the aqueous phase, while the depolymerized lignin remains primarily in the organic phase. Thus, liquid-liquid extraction can separate the sugars and hemi-cellulose from the brown liquor, resulting in clean depolymerized lignin.

The sugars and hemi-cellulose can be separated from the salt solution using standard membrane technology, where the aqueous salt solution is then recycled to the process. The sugars and hemi-cellulose are a product of the process in addition to the clean depolymerized lignin and the clean cellulose fibers.

Additional embodiments of the disclosure include:
1) A method of preparing a composite board, comprising:
soaking a first quantity of biomass fibers in methanol to yield a second quantity of methanol infused biomass fibers;
placing the second quantity of methanol infused biomass fibers into a first pressure vessel to increase pressure therein;
rapidly reducing pressure within the pressure vessel to yield a third quantity of methanol exploded biomass fibers;
placing the third quantity of methanol exploded biomass fibers into a second pressure vessel;
introducing methanol, hydrogen gas, nitrogen gas, and acid into the second pressure vessel to define a first admixture;
heating the first admixture under increased pressure to yield a quantity of unpurified depolymerized lignin;
mixing the quantity of unpurified depolymerized lignin with predetermined quantities of fiber, curing agent, paraffin wax, glyoxal, and dispersant to define a second admixture; and
bonding the second admixture with cardboard to yield a formaldehyde-free composite board;
wherein the composite board exhibits no more than four percent swelling upon exposure to water;
wherein the composite board has a modulus of at least 30 kpsia;
wherein the composite board has a tensile strength of at least 70 psia;
wherein the composite board returns to its original thickness after forty-eight hours of drying following a twenty-four hour immersion in water;
wherein the curing agent is selected from the group consisting of Polycup 9700, azideine, cyanuric acid, carbodiimide, gamma-aminopropyltriethoxysilane, and combinations thereof;
wherein the paraffin is selected from the group consisting of seventy percent chlorinated alkane, anionic water-based paraffin wax emulsion with a solid content of about forty-five percent, polyethylene wax, and combinations thereof; and
wherein the dispersant is styrene-maleic anhydride.

### Production of Rice Straw Fiber Board Using Lignin from Catalytically Depolymerized Rice Straw

Utilizing specific sources of lignin to create specialized products is also of great interest within the industry. For example, rice is one of the staple crops over a large part of Asia, South America, and North America. In 2017, one hundred and seventy-eight million hundredweight (CWT) of rice was produced in the US, and California has 70% of the USA medium grain rice production. Once the crop is harvested using mechanical combines, it leaves behind significant lengths of straw, that have traditionally been used as fuel (usually for direct burning with deleterious environmental effects), livestock feed, as a substrate for growing mushrooms or for production of biochar for improving soil conditions, and the like.

Although there are many pathways, the use of rice straw as a source of energy is limited. Mechanical devices like choppers quickly wear out, due to the presence of high quantities of abrasive silica in the straw. Ash content and volatile matter content in rice straw is also relatively high, as compared to wood and coal, with lower content of fixed carbon, as compared to coal. Fouling and failure of boiler parts due to melting occurs due to the production of ash having a relatively high alkali and potassium content.

Rice straw fiber is composed of 20% lignin, with 32% cellulose, 28% hemi-cellulose, 11% ash, and 9% of other materials, where the lignin is the natural binder, the cellulose is the reinforcing fiber and hemi-cellulose is a filler that provides minimal mechanical strength.

Previous methods that have been used to obtain lignin from rice fiber include ultrasound-assisted alkaline extraction; steam explosion and biological treatment; hydrothermal extraction; solvent extraction using bio-ionic liquid (with cholinium (choline chloride) as the cation and amino acids as the anions). While useful, these methods tend to suffer from inefficiency and the requirement of potentially hazardous chemistry.

Methods that have been proposed using rice fiber in composite boards with binder systems from the chemical industry include rice straw fiber board with modified surface using NaOH and modified soy protein isolate adhesives; medium and high-density rice fiber boards with methylene diphenyl diisocyanate (MDI) adhesive; fiberboard using rice straw and urea formaldehyde resin. Again, while useful, these methods tend to suffer from inefficient use of production energy and the need for unnecessarily complex and potentially hazardous chemistry. For example, the composition of current laminating resins is typically a phenol-formaldehyde mixture. For improved environmental safety both during manufacturing and in the ultimate in-home use as kitchen cabinet and furniture countertops, there is a desire to reduce the amount of both phenol and formaldehyde. In addition, there is a desire to use sustainable green products vs. formaldehyde and phenol which are produced from petrochemicals.

Thus, there remains a need for a way of utilizing lignocellulosic biomass, such as rice straw, to yield fiber board products that is more efficient and less dependent on complex and hazardous chemistry. The present novel technology addresses this need.

The present novel technology relates to a process for extracting and/or depolymerizing lignin as well as fibrous material from rice straw for use in the production of composite boards.

The objective is to produce a composite board where both the binder and the reinforcing fibers are made from rice straw, which is an agricultural waste product. Two results are detailed herein: (1) the method for catalytically degrading rice straw to obtain a product stream of cellulose that is relatively clean, namely substantially free of (a) input contaminants, such as silicates, dirt, and ash, as well as (b) output impurities, including but not limited to unprocessed lignin, repolymerized monomers, or residual catalyst, such as less than 10%, 9%, 8%, 7%, 6%, 5%, 4%, 3%, 2%, 1%, 0.9%, 0.8%, 0.7%, 0.6%, 0.5%, 0.4%, 0.3%, 0.2%, and 0.1% of such contaminant or impurities, and a material that includes depolymerized lignin and other products such as waxes, sugars, and hemi-cellulose; and (2) formulation of a binder system using the depolymerized along with appropriate curing agents that can be used with a mixture of the clean cellulose fibers and additional rice fibers to produce composite boards with desirable physical properties. One attractive feature of this approach is to produce a formaldehyde-free composite board. Initial analysis indicates that the material costs for the formaldehyde-free, rice board is approximately $0.22/kg ($0.10/lb) vs $0.37/kg ($0.17/lb) for the competitive formaldehyde-free product made using a PMDI resin. A $0.15/kg ($0.07/lb) material cost difference in a low margin business like composite boards is significant and there is opportunity to further reduce the material cost of the rice composite board.

One overall manufacturing process for laminating resin is summarized as follows. Steps include:
1. Lignin Resin Mixing Process. Depolymerized lignin produced from rice straw in a high-pressure reactor, with a nickel catalyst, was combined the appropriate curing agents and other additives.
2. A-Stage Cure. The depolymerized lignin with curing agents was heated to partially advance the cure in to control the viscosity of the resin mixture.
3. Resin Extension. The main component of the laminating resin in a traditional phenol-formaldehyde resin is extended by the addition of depolymerized lignin resin from the A-stage cure.
4. Kraft Paper Saturation. The resin mixture is brushed onto the Kraft paper using a small paint brush so that the paper is fully saturated with minimal bleed though of resin through the paper. The Kraft paper is not dripping wet, but tacky to the touch, where the resin should not be pooled.
5. B-Stage Cure. The resin impregnated Kraft paper is now subjected to a partial cure of the resin. The impregnated paper is heated in an oven at 130° C. for 1 minute on a first side of the laminate, turned over and then heated for an additional 1.5 minutes on the opposite side. The B-stage cure stiffens the Kraft paper as well as removes solvent which thereby reduces the flow of the resin.
6. Layup Procedure. The impregnated Kraft paper that has been partially cured in the B-Stage cure is laid up as follows: 1) topcoat, 2) décor paper, and 3) impregnated Kraft paper that has been B-Staged cured. The three-component laminate is placed between two metal plates, where the plate next to the topcoat layer is often a texture plate that is a stainless-steel plate textured with a wood grain or pattern. This assembly in now ready to be placed in the hot press.
7. Press Process. The laminate assembly is now placed in the hot press where it undergoes a two-step cure procedure. One commonly selected laminate size is 8.5 in. by 11 in. or 21.6 cm. by 28 cm. In the first cycle, 1283 psi pressure is applied as the press is heated from 68° C. to 115° C., where the overall process takes 13.5 minutes. The temperature ramp from 68° C. to 115° C. is typically timed to last about 7 minutes, and the temperature ramp is more typically a linear time/temperature relationship. The laminate assembly is held (soaked) at 115° C. for the remainder of the 13.5 minutes. This is immediately followed by the second cycle where the pressure is decreased rapidly to 428 psi and then the press platens are heated from 115° C. to 127° C. for a total of 8 minutes, where the (typically linear) heating ramp takes approximately 3 minutes after which the sample is soaked at 127° C. is for the remainder of the 8 minutes after which the fully cured laminate is removed from the press.
8. Cool Down Process. The laminate is then removed from the press and cooled, such as between two aluminum plates that act as heat sinks. Samples are cooled until they can be handled by hand without heat gloves.

After completion of Step 8 the cured laminate is removed from the press and its physical properties are evaluated.

In another embodiment, a formaldehyde-free fiber-based composite board can be produced as described above, wherein the board includes a fiber portion with a weight percentage of 80-95% and a resin portion with a weight percentage of 5-20%. The resin portion further includes a resin cure package and a wax-based surface modification package. The resin cure package defines a mixture of a catalytically depolymerized product of a fiber-based lignin, wherein the catalytically depolymerized product includes at least one compound selected from the group consisting of:

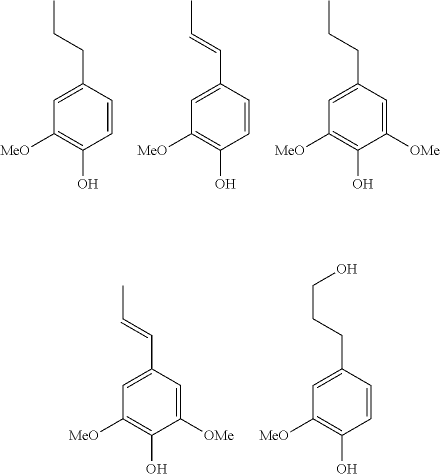

The other component of the biomass of rice straw material are available and likewise may be relevant, in addition to the above chemical. The wax-based surface modification package includes at least one wax material with a formula of CₙH₂ₙ₊₂, wherein n is between 15 and 40. The fiber is typically a rice-straw-based fiber.

The mixture of the resin cure package typically also includes at least one dialdehyde with a formula of OHC(CH₂)ₙCHO, wherein n is between 0 and 6. The mixture of the resin cure package typically incudes an anhydride, and that anhydride is typically maleic anhydride. The mixture of the resin cure package may also include a polyamide-epichlorohydrin as a crosslinking agent. The mixture of the resin cure package typically has a pH value of 6.5-7.5.

### Binder Resin and Method of Producing the Same

Binders are materials used to hold disparate materials together. Resin binders are widely used in construction for to hold together partition walls, restroom dividers, countertops, and the like. Resin binder systems nay be sorted into two grades, HPL (High Pressure Laminate, static press) and CPL (Continuous High-Pressure Laminate) differing in the method of manufacturing. The current choice of binder system is a phenol-formaldehyde mixture in a 1.4 to 2.2 mole ratio of formaldehyde (F) to phenol (P). Both phenol and formaldehyde are chemicals where environmental concerns are going to require reduction in VOC by 50%. The European Union is asking for a significant reduction for phenol and the California Air Research Board (CARB) is requiring these laminate materials to meet CARB2 limits with less than 0.7 ppm Formaldehyde in VOCs. Free phenol amounts in the current industry are 5-10% greater than the guidelines of the US EPA that are then mandated by each state with their own ppm requirement of unreacted phenol.

At the same time, industry demands are driving the development of resins for binder systems to meet increasingly stringent requirements for the reduction of carcinogenic and harmful chemicals. Thus, there is a need for an improved resin binder system that meets environmental standards as well as health and safety standards. The present novel technology addresses this need.

### Binder Resin System and Laminate Materials

The present novel technology relates to a process for depolymerizing lignin from a variety of forestry and agricultural waste sources such as wood fibers or rice straw. The depolymerized lignin can be used as a replacement, any portion thereof including total, for phenol, and the formaldehyde-free cross-linkers glyoxal and Polycup™ are used to reduce and/or eliminate the amount of formaldehyde used in an HPL and/or CPL. The components of the novel binder system may include:
1. Source for Eugenol (phenylpropanoid derived from guaiacol, 4-allyl-2-methoxyphenol) in an eugenol-based resin—may be unpurified depolymerized lignin monomer where a major component is eugenol; may be made from rice straw, corn stover, and/or from wood fiber; and/or may be sourced as pure dihydroeugenol from petroleum. Eugenol may be used to improve the properties of epoxy resins, including making them more fire resistant and increasing their thermomechanical properties. Eugenol may be used to create novel bio-based epoxy resins.
2. Urea and/or ethylene urea, which is used as additional monomer unit to decrease brittleness in the resin.
3. Glyoxal which is used as a cross-linking agent and as a formaldehyde substitute.
4. Glutaraldhyde which is used a cross-linking agent and as a formaldehyde substitute to reduced stiffness.
5. Polycup™ 9700. Polycup™ is a commercial cross-linking resin. Polycup™ is a water-soluble poly (amide epichlorohydrin), or PAE, resin. As sold, the secondary amine in the polyamide and the epichlorohydrin have reacted to form an azetidnium complex. Polycup™ comes in a variety of different grades, where Polycup™ 9700 has an amine enriched polymer with the lowest dichloropropanol (DCP) content and the highest pH. Thus, Polycup™ 9700 is compatible with the pH from the material in the depolymerized lignin reaction mixture and has attractive reaction conditions for the various cross linkers. Polycup™ 9700 is one of the Polycup™ resins that can be used for composite boards.
6. Potassium hydroxide (KOH) is used to catalyze the reaction between the lignin eugenol and the dialdehyde (i.e. glyoxal and/or glutaraldehyde) as well as change the pH to manufacture recommended reaction conditions for Polycup.
7. Phenol formaldehyde resin; specifically, a resole resin with a molecular weight of 300 to 650 g/mole that is approximately 60% resin by weight in a methanol solvent. Two different commercially available resins were investigated:
a. Arclin Continuous Press Laminate PF Resin, having a lower pH of 7.5 with a lower MW of 450 g/mole, 57% solids, and a F: P mole ratio of 1.8 mole percent.
b. Georgia Pacific® PF Resin, having a higher pH of 8.5, which provides higher water tolerance, 60% solids and a F: P mole ratio of 1.72 mole percent.
8. Kraft Paper. Kraft paper is a major component in the composite material. Typical specification of Kraft paper is medium density at 9 to 10 apparent density. Apparent density is defined as the measure of the weight of the paper in lbs/3000 sq.ft. divided by thickness in mils ( 1/1000 of an inch). The grade of paper is 160 to 280 grams per square meter (GSM). The paper is made predominantly of southern pine and the porosity of the Kraft paper is 10 to 20 seconds (porosity is measured by how long it takes 100 cc of air to travel though a 1-inch Gurley Porosity instrument). This paper is saturated with 30±2% by weight of resin, where the resin includes 6% by weight of volatiles before being placed in the press.
9. Waxes are used to improve water tolerance properties. Two waxes were used: (i) an experimental wax from Astro American Chemical Company designated Emulsion 002 Paraffin and Slack Wax and (ii) Michelman Inc. 66035 High Density Polyethylene Wax.

### Resin Cook/Mix Process

The resin cook process for the eugenol-based materials involves the following steps:
1. The eugenol from either the degraded wood/rice or the surrogate eugenol is added to glutaraldehyde/glyoxal curing agent with a water as well as the MeOH solvent and KOH catalyst.
2. This mixture is heated to 82° C. for 15 minutes—(pre-cook).
3. After the pre-cook, urea and Polycup™ are added to the mixture with additional KOH and heated to 82° C. for 10 minutes (second cook). The second addition of KOH ensures more basic conditions which are desired for reaction with Polycup™.
4. After the second cook, the new resin is added as an extender to the standard phenol formaldehyde laminating resin.

Resins were made consisting of between 50% to 75% of the traditional phenol-formaldehyde with the remainder from the pre-cooked eugenol-based resin, although the resins could contain as little as 25% of the traditional phenol-formaldehyde with the remainder from the pre-cooked eugenol-based resin, or even 100% pre-cooked eugenol-based resin. In addition, resins samples with 100% of the traditional phenol-formaldehyde resin currently used in the laminate industry were also produced in order to establish a baseline to which to compare the novel extended resins.

### Laminate Manufacturing Process

The process for manufacturing B-staged Kraft paper laminates is as follows:
1. Sheets of Kraft paper were supplied as rolls of Kraft of papers 5-foot wide and 6000 feet long. These were cut into more manageably sized sheets of 24-inch×24-inch. These sheets were cut into (i) 4-inch by 4-inch squares or (ii) 4-inch by 8-inch strips that were eventually cut into 4-inch by 4-inch squares after B-Stage curing. Three-inch by eight-inch strips were also cut.
2. Using a generic paint brush, the resin was brushed onto the Kraft paper making sure that (i) there was no resin rich puddled areas and (ii) there was complete coverage of the paper from edge to edge. The mass of the paper should approximately double after the resin is brushed on both sides of the paper (if the mass of the paper was 10 grams, the mass of the paper after impregnation was about 20 grams). The mass of the paper after impregnation was then measured.
3. The impregnated paper was dried in oven at 138° C. The samples were removed from the oven at one-minute intervals and weighed. When the weight of the impregnated paper was between 13 to 14 g for a wet paper that initially weighed 20 g, the A-stage part of the cure was complete. This typically took 6 minutes. The mass of the paper increased by 28 to 30% at the end of the A-stage; specifically, a 10-gram sheet of dry Kraft paper will weight 18 to 20-grams wet, which will decrease to between 13 to 14-grams prior to B-stage cure. At this point approximately 0.8 g of the sheet remain as volatiles (mainly as water and methanol but it also includes excess formaldehyde, phenol, furfural, and some diols).
4. Samples were visually inspected, where a dull sheen indicates that sufficient solvent has been removed during the oven drying process.
5. Two-ply laminates were produced by stacking two sheets of the A-Stage Cured Kraft paper together that were then sandwiched between two aluminum foil sheets coated with a mold release agent.
6. The sample assembly was placed in hot press for final B-Stage cure. For the smaller 4-inch by 4-inch samples, a Carver Press with 6-inch by 6-inch heated platens was used with the following conditions: 12500 pounds-force at a temperature between 135° C. to 147° C. for 5.5 to 8.5 minutes (except for one sample made in the “quick cycle” with a higher temperature of 175° C. and pressed for 0.8 minute). For the 3-inch by 8-inch samples a PHI 70-ton hydraulic press with 12-inch by 12-inch heated platens was used with the following conditions: 50 to 60 tons of force at 144 to 150° C. for 11 to 12 minutes.
7. After curing in the press, the samples were removed from the press and immediately cooled between two cold aluminum press platens that act as heat sinks. This ensures the laminates cool down into a flat form.

### Test Procedures

For proof-of-concept testing, the following tests were performed:
1. Visual Inspection. The laminates manufactured resemble that of what is called a “Backer-Laminate” without the associated décor overlay on top. Visual inspect was performed for smudges, streaks, bubbles, blisters, even distribution of resin and foreign particles. Specific items for examination included:
   a. Gloss. Dull finish is expected with little to no shiny spots which indicate excess resin.
   b. Color. Resin should turn clear or light Carmel color. Dark brown spots indicate over-curing.
   c. Warp and “Squareness”. Laminates immediately come out of the press and are cooled between two cold aluminum press platens. The cured laminate is evaluated for dimensional quality. Specific criteria include: Does the laminate lay flat on a table surface? Uniform thickness as measured with a micrometer. Flatness measured by measuring the lowest point to the highest point of any concavity. Evaluation of corners of laminate to determine if they are broken.
2. Boiling Water Resistance (ISO 4586). Using a heat plate, water is brought to a rolling boil, where samples are then dropped into the water and kept below the surface for 30 minutes. The industry standard is 2 hours, where the Purdue testing thus far has only been for 30 minutes. The surface finish is then examined with ratings from no visible change to surface blistering to delamination of the layers. The laminate thickness is then measured, and the percent increase is the Thickness Swell. The laminate is then weighed, and the percentage increase is the Water Absorption. Industry standard values are approximately 25% for Thickness Swell and 25% for Water Absorption.
3. Blister Test via Radiant Heat Strip Element Method. This test was performed to assess the effect of the radiant heat that is used to make a curved countertop surface. The test involved the use of 1600 watt two element radiant electric heater strips placed 10 cm (4-in) from the surface of the test specimen. The 7.5 cm by 20 cm (3-in by 8-in) samples were cut to 5 cm by 20 cm (2-in by 8-in) specimens and conditioned for 48 hours prior at immersion in an environment characterized by a temperature of 23° C. and relative humidity of 50%. Calibration strips with thermochromic ink indicated when the temperature had reached 163° C. (325° F.), which indicates the beginning of the test. The surface is observed as a function of time up to the point of blister or 120 seconds if no blister is observed, where damage such as discoloration, blistering, charring, crazing and/or deformation is observed via mirror at bottom of apparatus. The time at which any damage occurs was observed and recorded.

Samples were assessed as to whether they met ISO and NEMA standards (NEMA Standards Publication LD 3-2005: High-Pressure Decorative Laminates). These include but are not limited to the following:
1. Bandsaw and Drilling Test. Woodworking or metal blade may be used in the bandsaw. An electric drill with a drill bit of size 0.05 mm is used. Cut or drill laminate and observe for crack propagation and/or feathering of material.
2. Bending Test. This is more of a test of the resin and performed by manufacture specification. No industry standard exists. Tests are conducted on a three-point bend apparatus via Instron or DMA.
3. Internal Bond. A three-ply laminate is produced. Similar to internal bond test used with MDF composite boards, the sample is glued to two metal surfaces and pulled apart in an Instron. Values of the force at break are approximately 120 lb/in². This test is rarely conducted in industry, but for a new resin the test may be helpful.
4. Post Forming. Post forming test for laminate requires a two-element heater and a radius forming apparatus. Place the laminate face down onto heating element apparatus. Then heat the laminate to the 163° C. forming temperature. Allow forming apparatus to bend laminate into shape and record observations/damage. Failure is defined by the observation of fractures, blisters, and/or crazing.
5. Ball Impact Resistance. Test for the core of the laminate to avoid damage from a falling 3.8 cm (1.5 in) diameter polished stainless-steel ball weighing 224±3 grams. The test specimen is 30.5 cm by 30.5 cm (12×12 in) laminate that is no less than 6 mm thick. The ball is dropped from ever increasing heights until visible damage such as fractures is observed, at which point the height is recorded.
6. Dimensional Stability. This test measures the changes in laminate shape for a wide range of temperatures and relative humidity in a humidity chamber. The laminate size is at least 120 mm×120 mm. Install pin-prick points for the caliper to measure in accordance with NEMA Testing. The midpoint is located between two adjacent corners and 10 mm from the edge and marked. Repeat for the other three sides of the sample. These marks will be used after the test if the sample warped or changes dimensions. Measure initial and final mark points. Two conditions are tested: (i) in an oven at 70° C. for 24 hours and (ii) in a humidity chamber at 90% humidity at 40° C. for seven days.

### EXAMPLES

### Example 1: Depolymerization of Lignin Feedstock for the Manufacturing of Composite Board

### Example Depolymerized Lignin Feedstock

Depolymerized lignin feedstock was provided as described above. The lignin monomer feedstock was prepared from depolymerization of poplar wood chips. Specifically, 100 to 200 g of 70 mesh dried wood biomass was reacted under batch conditions with 10% by weight catalyst in 1-2 L methanol solvent under hydrogen pressure (30-50 bar) at 200-225° C. for several hours. Solid filtration followed by solvent concentration under rotary evaporation provided the lignin methoxyphenols feedstock used in resin preparations.

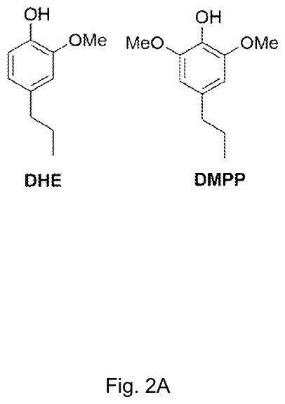

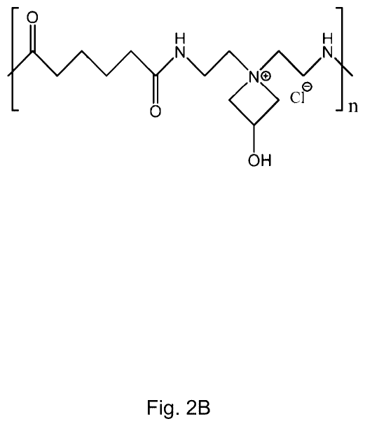

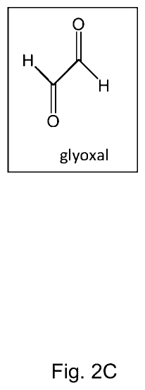

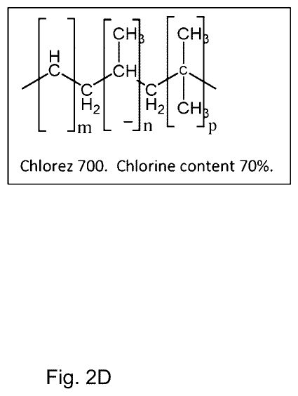

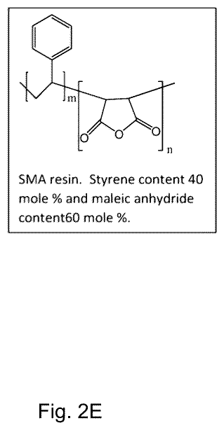

The depolymerized lignin resin was used as received. Specifically, the cellulosic fraction of the wood chips had been removed (except for a limited number of tests) and greater than 95% of the methanol solvent has also been removed. However, the remaining reaction mixture was not purified any further. This mixture contains propyl methoxyphenols (see FIG. 2A) as the main components, but also includes other minor reaction products including xylose as well as residual methanol solvent.

One attractive feature of the binder technology described herein is that it works with the unpurified reaction mixture after the relatively easy removal of the lignin-free cellulose solid byproduct and most of the methanol solvent, thereby avoiding the need for costly separation processes. The ability to avoid costly separation operations significantly affects the overall economics of the lignin monomer binder system.

### Production of Binder Resin

Using the depolymerized lignin mixture as the main component in the binder system, a formulated binder system for composite board use was produced. The components in the formulation include:
1. Unpurified depolymerized lignin monomer mixture. As used herein, purity provides a product substantially free of contaminants and impurities, such as less than 10%, 9%, 8%, 7%, 6%, 5%, 4%, 3%, 2%, 1%, 0.9%, 0.8%, 0.7%, 0.6%, 0.5%, 0.4%, 0.3%, 0.2%, and 0.1% of contaminant or impurities.
2. Polycup™ 9700 curing agent. POLYCUP is a registered trademark of Solenis Technologies, LP, a Delaware Limited Partnership, 3 Beaver Valley Road, Suite 500, Wilmington, DELAWARE, 19803, reg. no. 0863338. Polycup™ is a commercial crosslinking resin. Polycup™ is a water soluble polyamide-epichlorohydrin (PAE) resin curing agent. The secondary amine in the polyamide and the epichlorohydrin have reacted to form an azetidnium complex as shown in FIG. 2B. Polycup™ comes in a variety of different grades, where Polycup™ 9700 has an amine enriched polymer with the lowest DCP content and high pH so that it is compatible with both the extractables in the lignin reaction mixture and the various cross linkers.
3. Fiber. Different types of wood fiber are used for different applications, wherein hard-wood and soft-wood fiber from mixed elm, oak, ash, hickory, maple, chestnut, birch, and poplar were selected, the mixture including low amounts of soft wood such as spruce, pine and hemlock. These were sourced from within a 100-mile radius of Clarion, PA. These woods are typically used in the production of medium density fiber (MDF) boards. Characteristics of the fiber product include a soft, fibrillated fluffy texture with a refined, short fibers with 10% moisture.
4. Glyoxal. Glyoxal is a small molecule organic compound that is used in the wood/paper industries to crosslink cellulosic material in wood/paper products (see FIG. 2C).
5. Wax. Two different types of paraffin-based waxes were investigated. Chlorez™ 700 is a powdered solid paraffin-based wax (see FIG. 2D) that is 70% chlorinated (70% chlorinated alkane), that imparts both water repellency as well as some flame retardancy. During manufacture Chlorez™ will off-gas HCl which might play a role in the reaction of the Polycup™ with the lignin monomer. ULTRALUBE™ E-345 is a paraffin wax used for water repellency that is an anionic water-based paraffin emulsion with 45% solids content. The molecular weight of Chlorez™ is approximately 350 g/mole while the molecular weight of ULTRALUBE™ is between 280 to 420 g/mole.
6. Styrene-Maleic Anhydride (SMA). SMA is a random copolymer produced from a monomer mixture of styrene and maleic anhydride (see FIG. 2E). SMA is traditionally used in the wood/paper industries as a dispersant for the paraffinic wax and to aid in better wetting of the wood fibers. The molecular weight is 3500 g/mole.

The components above make the main mixture used in the binder resin formulation; however, other types of curing agents, additives, and the like have also been studied and may likewise be selected. Other compounds that have been studied include:
7. Azideine is a potential alternative crosslinker to the Polycup™.
8. Cyanuric acid is a potential alternative crosslinker to the Polycup™.
9. Carbodiimide is a potential alternative crosslinker to the Polycup™.
10. An aminosilane, specifically gamma-aminopropyltriethoxysilane, which is a potential alternative crosslinker to the Polycup™.

In general, the curing agent may be selected from the group consisting of Polycup™ (specifically Polycup™ 9700, although other Polycup™ formulations may be elected), azideine, cyanuric acid, carbodiimide, gamma-aminopropyltriethoxysilane, and combinations thereof.

The ten components above were explored to determine which components would provide an alternative to the current formaldehyde based thermoset resins. In addition, a traditional phenol-formaldehdye resin system was prepared as a reference standard, serving as the target material with which to compare the properties of the instant novel binder systems.

### Composite Manufacturing Process

Test samples of fiber filled composite were produced using the following procedure:
1. Select the composition for the composite sample
2. Preheat both platens on press to 192° C.
3. Measure the fiber amount in grams and place into a vessel
4. Add in processes cellulose material if desired
5. If powdered solid wax, such as Chlorez™ 700, is used, add the wax to the cellulose fibers and mix until a homogeneous admixture is yielded
6. Measure the specified amount of water, methanol, and lignin monomer, and glyoxal; water is about 25 weight percent of this mixture and methanol is about 15 weight percent of this mixture
7. If the E-345 wax is used, mix with water along with SMA dispersant; premix the E-345 wax with water to form an emulsion at a 1:3 ratio of wax to water; add the SMA dispersant and mix until homogeneous
8. Spread the lignin monomer/glyoxal mixture from a pipette over the fibers and mix the resulting wet fiber mixture well
9. Spread the wax and SMA mixture from a pipette over the fibers and mix the resulting wet fiber mixture well
10. A cardboard template (about 2 mm thick) with a cutout approximately 3″×2″ is covered with aluminum foil; release agent is applied between the foil and an aluminum plate on a hot press to prevent any curing of the template to the plates of the hot press.
11. The mixture of fiber, cross-linking agent lignin, and wax is placed into a mound in the center of the cardboard template, where the template is already at the cure temperature (in this example 192° C.)
12. A piece of aluminum foil is placed over the “mound” of fibers, the release agent is wiped on the top surface of the aluminum foil to prevent bonding with the platens of the hot press and the aluminum foil on the template
13. The press is closed and 1400 pounds force is applied; the mixture is cured at 192° C. for 6 minutes; the force from the press is used to make sure that fiber-binder mass is consolidated, but because the template is only made from cardboard there will be no significant internal pressure curing the cure cycle—this cure cycle mimics the thermal/pressure history in a continuous belt press used in a modern composite board manufacturing facility
14. Open press, remove mold with sample from press and carefully remove composite sample from template; the cured specimen does not stick to the aluminum foil and the release agent prevents the various aluminum parts for sticking together
15. Trim edges of the cured composite sample with scissors for uniformity; remove the edges, especially for moisture absorption tests, because the pressure at the edges is less than at the center and thus the fiber compaction is not homogeneous

### Testing Procedure for Composite Samples

Various tests were performed to evaluate the basic cure chemistry of the various compositions. These tests included:
1. Brittle Failure. The samples produced after curing in the press were tested to screen for gross mechanical behavior. Specifically, the samples were bent with modest force. If the samples snapped during this hand test, they were classified as brittle. Compositions that exhibited extreme brittle behavior were eliminated from the test matrix.
2. Extraction. Material that was not immobilized by the curing reaction was determined via water extraction using a modified version of TAPPI (Technical Association of the Pulp and Paper Industry) method T204 based upon the ASTM T204: Solvent Extractives of Wood and Pulp procedure. The samples are placed onto cups and soaked in approximately 500 mL of water for 24-hours for the water absorption test. Once the 72-hour period is complete, the samples are removed from the cups and the color of the remaining water is observed. Yellow water indicates “leaching” of unreacted lignin monomer material. This indicates a poor cross-linking. The clearer the water, the more lignin material was cross-linked. A qualitative ranking scale was employed: Poor (or 3) samples exhibited a strong yellow color in the liquid in the container; Moderate (or 2) samples showed a yellow tinted liquid; Good (or 1) samples showed little to no yellow tint in the extraction liquid. The best samples remained visually clear, indicating no leaching of unreacted material by water, which were also rated Good (or 1).
3. Water Absorption. The industry standard test requires that boards be subjected to a 24-hour period of water submersion and then dried at room humidity and temperature. The ASTM D1037-99: Standard Test Methods for Evaluating Properties of Wood-Base Fiber and Particle Panel Materials (Sections 100-103 and Sections 105-107) was employed. The thickness swell and water mass absorption is observed in 24-hour intervals after the initial 24-hour submersion period. Samples that perform very well absorb the least amount of water and return to original thickness and mass after a 72-hour drying period. Note: the water absorption test is not really concerned with how much water is absorbed, but rather how fast the water de-absorbs-this is a desirable application feature, where if composite flooring or furniture get wet it returns to its original state upon drying, that has insurance implications.
4. Pull Test. The mechanical properties of selected specimens were determined using the ASTM D952: Standard Test Method for Bond or Cohesive Strength of Sheet Plastics and Electrical Insulating Materials. Specifically, the composite sample based were first bonded to pull rods using 160 grams per square meter of binary epoxy adhesive, and then the pull rod with composite samples was subjected axial deformation in a tensile testing instrument with 500 psi load cell. Both the initial modulus and tensile failure were recorded. Only measurements that resulted in cohesive failure in the center of the composite material were recorded. Typical examples of composite board failure are shown in the attached figure, where it is clear that the failure is cohesive.

There are a number of tests that are used by the composite board industry including: (a) water absorption (see 3 above), (b) the strength from a pull test (see 4 above), (c) screw holding test, (d) lap shear, (e) rupture test (MOR) and f) damage and stability—all of which are defined in ASTM D1037-99. Tests (c) through (f) are all related to (a) and (b), where the simple screening test in (a) serves as a surrogate for (b) that can eliminate compositions that are too brittle. Thus, after initial screening using the brittle test, extraction and water absorption, the more involved pull test was performed on candidate specimens that looked the most promising.

### Effect of Composition on Material Properties

The properties of the new lignin binder system are compared to (i) the traditional urea-formaldehdye system and (ii) for a polymeric methylene diphenyl diisocynante (PMDI) used in the wood composite board industry.
1. For the urea-formaldehyde system, the composition (all by weight percent) used in industry for this system is: 77 to 84% fiber, 7% water, 8 to 15% of urea-formaldehyde (in the ratio of 1.2% formaldehyde: urea) and 0.5 to 1.5% wax. We produced test panels for the urea-formaldehyde systems using exact composition numbers. The physical properties for panels with the urea-formaldehyde system are: water absorption=8 to 20% increase in thickness, 10% increase in weight, modulus=0.10 kpsi and strength=35 psi.
2. For the PMDI binder system, the composition (all by weight percent) used in industry for this system is: 61% fiber, 15% polyethylene fiber, 12% Acrodor® (BASF water-based acrylic resin), 12% Wollastonite calcium. The polyethylene fibers have been added to PMDI in order to make a wood-plastic composite which is a very high-end system, where the polyethylene fibers give both added strength as well as improved moisture absorption characteristics. Test panels for the PMDI system were produced using the exact above composition. The physical properties for the panels are water absorption=7.3% increase in thickness and 21% increase in weight, initial modulus=15.5 kpsi and strength=41.2 psi.

These properties provide a target that the new lignin-based system should meet or exceed. Based upon these numbers we have described a qualitative metric for performance of new resin systems:
1. Brittle failure: 1, Good—Samples remained stiff to the hand and had little give when a small force is applied; 2, Moderate—These samples bent or cracked under a small bending force applied by hand; 3, Poor—These samples would immediately crack with a small bending force OR did not form a cohesive panel after leaving the press.
2. Extraction: 1, Good—Clear solution; 2, Moderate—Pale yellow solution; 3, Poor—Heavily yellow solution-poorer cross-linking
3. Water Absorption: The thickness swell here is measured 48-hours after the 24-hour soak period. Poor—Thickness swell more than 10%; Moderate—Thickness Swell between 7% and 10%, Good—Thickness Swell less than 7%.
4. Pull Test: Poor—modulus<15 KPSI units and strength less than 25 psia; Moderate—modulus between 15 to 25 kpsi and strength modulus between 25 to 70 psia; Good—modulus greater than 25 kpsi and strength greater than psia.

The specification of poor/OK/good is consistent with the assessment of experts in composite boards.

### Initial Screening of Crosslinking Chemistry for Lignin Monomer Binder

Screening tests on the effects of composition of the new binder system on the physical properties of the composite test specimens is shown in Table 1. The objective of this initial study is to determine the components of the cure package needed to polymerize the lignin monomer.

The lignin extraction and depolymerization reaction produces a reaction mixture that includes (i) cellulose chips from the original wood used to produce the lignin monomer and (ii) a mixture of the depolymerized lignin with some hemi-cellulose, sugars and residual methanol solvent. The ‘process cellulose chips’ in Tables 1 through 4 is the cellulose from the lignin extraction and depolymerization reaction.

Examining the initial screening data in the Tables, one sees that when Polycup™ is used as the main component in the cure reaction (samples B, F, G and M) that samples with acceptable properties are produced, although if only a small amount of Polycup™ is used (samples A and B) the extraction test indicates that not all of the material is fully incorporated in the thermoset. Examining samples F and G, one sees that incorporating the process cellulose chips did not adversely affect the physical properties, at least as measured in these screening tests. The only other formulation that produced acceptable properties was the cure package that used azideine. As a result of these tests, cure system involving polyamine, cyanuric, carbodiimide and gamma-aminopropyltriethoxysilane were not considered further, although it is possible with additional work the amounts and cure cycle could be modified to increase the efficacy of these systems.

### Investigation of Binder Systems for Cross-Linking Resin System and Water Absorption

The second experimental tranche was to focus in on the Polycup™ and azideine cure packages, where we now added to additional components to the formulation: (1) glyoxal and SMA to bind the sugars and hemi-cellulose that are also part of depolymerized lignin monomer mixture and (2) various waxes to improve the water absorption properties of the composite material. Examining the data in Table 2 we observed:
1. With the addition of waxes it is possible to decrease the amount of lignin in order to achieve the same water absorption behavior (although composite strength may require the same, or even more, lignin upon addition of the wax). Notice, that all ‘green’ thickness swell samples in Table 2 are superior to the current urea-formaldehyde system with a thickness swell of 8% or greater. The no-wax Sample P has 26 wt % lignin monomer with a 2% thickness swell; in contrast, Samples U, V, AA, AB and AC use between 19 to 22 wt % of lignin monomer and still obtain acceptable water absorption behavior. A potential mechanism is that the more tightly cross-linked binder system that occurs for high lignin monomer content reduces water absorption, where if wax is present and coats the fiber then the network does not have to be as tightly cross-linked to achieve similar water absorption characteristics. Note: the phenolated species in lignin is about 45 wt % of the depolymerized-lignin, where the remaining material is 45 wt % disaccharides and 10% other components.
2. In addition to wax being able to reduce the amount of lignin monomer from upper 26 to 31 weight percent to between 19 to 22 weight percent, less glyoxal is required needed (see P through T as compared with Z through AC).
3. Examining the data for Samples S and W, it is clear that simply removing Polycup™ (Sample S) or removing lignin material (Sample W) will result in poor board properties. However, the extraction test for Sample S is interesting as it shows increasing glyoxal with decreased leaching.
4. The cationic wax caused the samples to fail prematurely and not form a cohesive board. The data may indicate that increasing the ionic character of the reaction mass affects the cure chemistry of Polycup™ with the depolymerized lignin.
5. In using Epoline® wax, the amount of water adsorbed decreased as the amount of Epoline® was increased, but the mechanical properties were significantly decreased.
6. Both Chlorez™ and ULTRALUBE™ E-345 showed the promising results. Sample V with PE 668 (polyethylene wax) was promising as well but required that the powdered PE 668 wax be heated and “melted” to the fibers before being placed into the press.

Based upon the analysis above, only Chlorez™ 700 and ULTRALUBE™ E-345 passed onto the subsequent tranche.

TABLE 1
Screening Tests for Determination of Cure Package for Lignin Monomer (compositions in wt. %).

| Sample No. | A | B | C | D | E | F | G | H | I | J | K | L | M | N | O |
|---|---|---|---|---|---|---|---|---|---|---|---|---|---|---|---|
| Fiber | 78 | 78 | 86 | 76 | 46 | 76 | 46 | 46 | 69 | 66 | 67 | 67 | 69 | 66 | 69 |
| Lignin | 22 | 22 | 13 | 22 | 22 | 22 | 22 | 22 | 26 | 29 | 27 | 27 | 26 | 29 | 25 |
| Monomer | | | | | | | | | | | | | | | |
| Mixture | | | | | | | | | | | | | | | |
| Process | 0 | 0 | 0 | 0 | 30 | 0 | 30 | 30 | 0 | 0 | 0 | 0 | 0 | 0 | 0 |
| Cellulose | | | | | | | | | | | | | | | |
| Chips | | | | | | | | | | | | | | | |

Cure Package

| | | | | | | | | | | | | | | | |
|---|---|---|---|---|---|---|---|---|---|---|---|---|---|---|---|
| Polycup ™ | .1 | .15 | 0 | 0 | 0 | 2.6 | 2.6 | 0 | 3.6 | 0 | 0 | 0 | 3.6 | 0 | 0 |
| Azideine | 0 | 0 | 1.5 | 2.6 | 2.6 | 0 | 0 | 0 | 0 | 4.3 | 0 | 0 | 0 | 4.3 | 0 |
| Cyanuric | 0 | 0 | 0 | 0 | 0 | 0 | 0 | 2.5 | 0 | 0 | 0 | 0 | 0 | 0 | 0 |
| Silane | 0 | 0 | 0 | 0 | 0 | 0 | 0 | 0 | 0 | 0 | 0 | 0 | 0 | 0 | 3 |
| Glyoxal | 0 | 0 | 0 | 0 | 0 | 0 | 0 | .25 | 1.5 | 1.5 | 6 | 1.5 | 1.5 | 1.5 | 3 |
| SMA | 0 | 0 | 0 | 0 | 0 | 0 | 0 | 0 | 0 | 0 | 0 | 0 | 0 | 0 | 0 |
| Carbodiimide | 0 | 0 | 0 | 0 | 0 | 0 | 0 | 0 | 0 | 0 | 0 | 4.5 | 0 | 0 | 0 |
| Tests | | | | | | | | | | | | | | | |
| Water | 6.7‡ | 3.4† | NA* | 13.1 | 20.3 | 13.4 | 15 | 28.3 | 9.2‡ | 10.2 | 9.89‡ | 19.6 | 7‡ | 6.7‡ | 14.4 |
| absorption; % | | | | | | | | | | | | | | | |
| thickness | | | | | | | | | | | | | | | |
| swell after 48 | | | | | | | | | | | | | | | |
| hrs drying | | | | | | | | | | | | | | | |
| Brittle - Hand | 2‡ | 1† | 3 | 3 | 3 | 1† | 1† | 3 | 3 | 2‡ | 3 | 3 | 2‡ | 1† | 1† |
| Test | | | | | | | | | | | | | | | |
| Extraction | 2‡ | 2‡ | NA* | 3 | 1† | 1† | 1† | 2‡ | 1† | 1† | 2‡ | 2‡ | 1† | 2‡ | 3 |

*Sample C broke in press
Cells with Test Data: Good - †; OK - ‡; Poor - No symbol.

TABLE 2
Screening Tests for Determination of Cure Package for Lignin Monomer and Wax for Water Absorption (compositions in wt. %).

| Sample No. | P | Q | R | S | T | U | V | W | X | Y | Z | AA | AB | AC |
|---|---|---|---|---|---|---|---|---|---|---|---|---|---|---|
| Fiber | 84 | 60 | 72 | 58 | 65 | 58 | 68 | 72 | 69 | 70 | 72 | 72 | 63 | 63 |
| Lignin Monomer | 26 | 31 | 25 | 28 | 26 | 26 | 19 | 19 | 19 | 19 | 19 | 19 | 22 | 22 |
| Mixture | | | | | | | | | | | | | | |
| Process Cellulose | 0 | 0 | 0 | 0 | 0 | 0 | 0 | 0 | 0 | 0 | 0 | 0 | 0 | 0 |
| Chips | | | | | | | | | | | | | | |
| Polycup ™ | 5.7 | 0 | 0 | 0 | 0 | 4.4 | 5.5 | 5.5 | 5 | 5.5 | 3.5 | 3.3 | 4.4 | 3.3 |
| Azideine | 0 | 5.5 | 0 | 0 | 0 | 0 | 0 | 0 | 0 | 0 | 0 | 0 | 0 | 0 |
| Silane | 0 | 0 | 0 | 0 | 0 | 0 | 0 | 0 | 0 | 0 | 0 | 0 | 0 | 0 |
| Glyoxal | 4.3 | 4.3 | 0 | 7 | 4.4 | 0 | 3.4 | 3.3 | 3.5 | 3.5 | 2.2 | 2.1 | 2.5 | 2.5 |
| SMA | 0 | 0 | 0 | 7 | 4.4 | 4.4 | 0 | 0 | 0 | 0 | 3.3 | 1 | 2.5 | 1 |
| Wax | | | | | | | | | | | | | | |
| Carbowax ™ | 0 | 0 | 2.8 | 0 | 0 | 0 | 0 | 0 | 0 | 0 | 0 | 0 | 0 | 0 |
| Chlorez ™ 700 | 0 | 0 | 0 | 0 | 0 | 7.3 | 0 | 0 | 0 | 0 | 0 | 0 | 0 | 0 |
| UltraLube ™ E-345 | 0 | 0 | 0 | 0 | 0 | 0 | 3 | 0 | 0 | 0 | 3 | 0 | 6 | 0 |
| PE 668 | 0 | 0 | 0 | 0 | 0 | 0 | 1.1 | 0 | 0 | 0 | 0 | 0 | 0 | 0 |
| Epoline ™ | 0 | 0 | 0 | 0 | 0 | 0 | 0 | 0 | 0 | 2.3 | 0 | 5.3 | 0 | 8.3 |
| Cationic Wax | 0 | 0 | 0 | 0 | 0 | 0 | 0 | 0 | 3.8 | 0 | 0 | 0 | 0 | 0 |
| Tests | | | | | | | | | | | | | | |
| Water Absorption; % | 2† | 3.3† | 9.8‡ | 5.9‡ | 2.8† | 1.2† | 0.6† | NA* | NA* | 10 | 4.1† | 4.1† | 0† | −1.6† |
| thickness swell, 48 hrs | | | | | | | | | | | | | | |
| drying | | | | | | | | | | | | | | |
| Extraction | 1† | 1† | 3 | 1† | 3 | 2‡ | — | — | — | — | — | — | — | — |
| Brittle - Hand Test | 2‡ | 3 | 1† | 1† | 3 | 2‡ | 1† | 3 | 3 | 2‡ | 1† | 2‡ | 1† | 2‡ |

*Samples W and X broke in press
Cells with Test Data: Good - †; OK - ‡; Poor - No symbol.

### Refinement of Binder Systems for Water Absorption

In the third experimental tranche, the focus was tightened to the most promising formulations. Specifically, (i) only two wax systems were considered—Chlorex™ and ULTRALUBE™ E-345 and (ii) the amounts of Polycup™, glyoxal and SMA were optimized to provide optimal water absorption behavior. The results of the brittle test and water absorption are shown in Table 3. For these systems the time dependent water absorption was also measured and is plotted in FIG. 7.

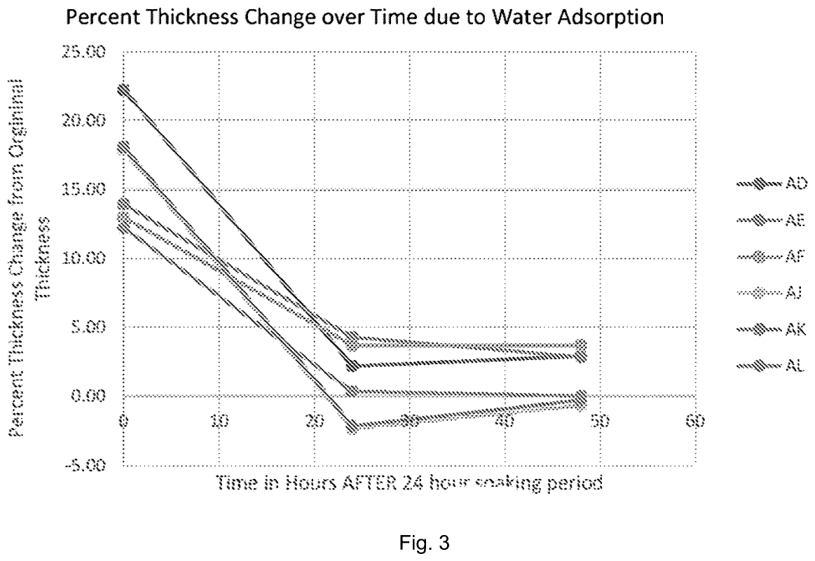

Examining the data in Table 3 and FIG. 3 we observe:
1. The thickness of the sample immediately increases upon immersion in water and then decreases (note: the zero time in FIG. 3 is after first soaking in water for 24 hours). This decrease is because the moisture is leaving the sample, as compared to the industry standard urea-formaldehyde system where the thickness increases after drying for 48 hours following the 24-hour soaking period range from 8 to 20%.
2. Samples below show that the optimal results for water absorption were achieved using a combination of ULTRALUBE™ E-345 and Chlorez™ 700. With the appropriate ratio of these two waxes it is possible that absorbed water evolves into the atmosphere as shown in samples AJ and AK.
3. The addition of process cellulose chips (Sample AK) made the board too pliable in the mechanical test. This is probably a result of the small length and particle size of the process cellulose material.
4. The moisture absorption results for samples AD through AL are significantly better than the current industry standard of 7 to 20% thickness swell.
5. The data in FIG. 3 shows the rate of drying. Samples AD, AK, AL show a higher rate of drying, but have a larger initial thickness swell. Samples AE and AF exhibit permanent deformation after the 24-hour water soak with surface fibers becoming “fluffier”.

The tranche summarized in Table 3 shows that with the appropriate choice of waxes a binder system based upon the depolymerized lignin can be developed that has superior moisture absorption properties than the current urea-formaldehyde systems.

TABLE 3
Refinement Tests for Finalization of Cross-linking Resin
System with Water Absorption (compositions in wt. %)

| Sample No. | AD | AE | AF | AJ | AK | AL |
|---|---|---|---|---|---|---|
| Fiber | 67 | 63 | 66 | 66 | 44 | 65 |
| Lignin Monomer | 20 | 23 | 20 | 20 | 18 | 18 |
| Mixture | | | | | | |
| Process Cellulose | 0 | 0 | 0 | 0 | 22 | 0 |
| Chips | | | | | | |

Cure Package

| | | | | | | |
|---|---|---|---|---|---|---|
| Polycup ™ | 4.4 | 4.4 | 3 | 4.3 | 3.8 | 4 |
| Glyoxal | 2.5 | 2.5 | 2 | 2.3 | 2.4 | 1.9 |
| SMA | 2.2 | 2.2 | 1 | 2 | 1.9 | 2 |
| Wax | | | | | | |
| Chlorex ™ | 0 | 0 | 7 | 2.5 | 4.7 | 7.3 |
| UltraLube ™ E-345 | 4.3 | 4.8 | 0.8 | 3 | 3.8 | 2.4 |
| Test | | | | | | |
| Water Absorption; | 2.9† | 2.9† | 3.7† | −0.7† | −0.3† | 0† |
| % thickness | | | | | | |
| swell, 48 hrs | | | | | | |
| drying | | | | | | |
| Brittle - Test | 1† | 2‡ | 1† | 2‡ | 3 | 1† |

Cells with Test Data: Good - †; OK - ‡; Poor - No symbol.

### Evaluation of Binder Systems for Combined Water Absorption and Mechanical Strength

The results of final experimental tranche are shown in Table 4, where now for the first time obtained quantitative measurements of the initial modulus and strength were obtained. Examining the data in Table 4 it is observed:
1. Water absorption is far superior in composite boards made from the depolymerized lignin as compared to industry standard. Specifically, the current materials standard for thickness swell is between 8 to 20 percent; in contrast, composite boards made with the depolymerized lignin monomer only exhibit swelling of 0 to 4%.
2. The sample AI exhibited a modulus of 37.5 kpsia. The composite made from the urea-formaldehyde samples only had a modulus of 0.010 kpsia modulus, where this low modulus was a consequence of using a small amount of formaldehyde to control emissions. The 15% polyethelyene enriched PDMI sample was able to achieve 15.5 kpsia, which is considered acceptable for many composite board applications.
3. Tensile strength of sample AI is excellent with a value of 87 psia as compared to 35 psia for the standard urea-formaldehyde composite. In addition, the water absorption is also excellent where the specimen returned to its original thickness after 48 hrs of drying following 24 hrs of emersion in water.

Based upon the data in Table 4, sample AI has the best combination of properties, although future improvement in properties and or reduction of material costs is possible.

TABLE 4
Determination of Cross-linking Resin System with Water Absorption
and Mechanical Strength Test (compositions in wt. %)

| Sample No. | AG | AH | AI |
|---|---|---|---|
| Fiber | 68 | 63 | 64 |
| Lignin Monomer | 20 | 22 | 21 |
| Process Cellulose Chips | 0 | 0 | 0 |
| Cure Package | | | |
| Polycup ™ | 3 | 4.9 | 2.8 |
| Glyoxal | 2 | 3.1 | 2.3 |
| SMA | 1.3 | 2.5 | 2.5 |
| Wax | | | |
| Chlorez ™ 700 | 6 | 0 | 8 |
| UltraLube ™ E-345 | 0 | 4.5 | 0 |
| Tests | | | |
| Water Absorption; | −0.7^{†} | −0.3^{†} | 0^{†} |
| % thickness swell, | | | |
| 48 hrs drying | | | |
| Brittle Hand Test | 2^{‡} | 1^{†} | 1^{†} |
| Pull Test | | | |
| Modulus (kpsia) | 18.8^{‡} | 11.4 | 37.5^{†} |
| Tensile Strength (psia) | 29.4^{‡} | 25.6^{‡} | 81.2^{†} |

Cells with Test Data:
Good - ^{†};
OK - ^{‡};
Poor - No symbol.

### Summary

Based upon the data in Table 4 we have been able to develop a formaldehyde-free binder system using the depolymerized lignin monomer (including additional sugars, hemi-cellulose and residual methanol solvent) that has water absorption, modulus and tensile strength properties that are superior to that of the current binder systems used for wood-based composite board products. As shown in Table 5, the AI system is substantially better than the current urea-formaldehyde and PDMI with polyethylene systems, where (i) the water absorption after 48 hrs of drying is essentially zero as compared to thickness changes of between 7 and 8% for the two industry standards and (ii) both the modulus and tensile strength for the lignin monomer system is more than twice that of the two current materials. Thus, the formulated lignin monomer system exhibits significantly better physical properties that the current binder systems for composite boards and is formaldehyde free.

TABLE 5
Comparison of Urea-Formadehyde, PDMI and lignin monomer
water absorption and mechanical properties

| | Urea- | | Lignin Monomer; |
|---|---|---|---|
| Material | formaldehyde | PDMI | Sample AI |
| Tests | | | |
| Water Absorption; | 8.0^{‡} | 7.3^{‡} | 0^{†} |
| % thickness swell, | | | |
| 48 hrs drying | | | |
| Pull Test | | | |
| Modulus (kpsia) | 0.10 | 15.5^{‡} | 37.5^{†} |
| Tensile Strength (psia) | 35.0^{†} | 41.2^{†} | 81.2^{†} |

Cells with Test Data:
Good - ^{†};
OK - ^{‡};
Poor - No symbol.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

### Example 2: Production of Rice Straw Fiber for the Manufacturing of Composite Board

### Production of Depolymerized Lignin from Rice Straw

In a first embodiment, a reaction mixture was prepared, consisting of 15 g of rice straw fibers in 300 ml of methanol with 1.5 g of nickel on activated carbon catalyst. The activated nickel catalyst was prepared by incipient wetness impregnation of nickel nitrate hexahydrate solution (2.76 gram salt in 8 mL de-ionized water), on 5 grams of 100 mesh screened activated carbon. This mixture was oven air dried for 24 hours, followed by oven drying at 120° C., and finally treated in 50 standard cubic centimeters flow of nitrogen in a tube furnace, for two hours, with heat ramp of 1 hour. The resulting catalyst sample was cooled in the continuous nitrogen flow to room temperature and stored in glass vials prior to use. The reaction mixture was a fiber slurry that consisted of fibrous chunks settled at the bottom of the slurry.

The reaction mixture described above was added at room temperature to a 600 ml stainless steel reactor. The reaction mass was heated over 60 mins to 200° C. where the reaction generated a pressure of 40 bar. This reaction was sub-critical, where the critical point for methanol is 239° C. at a pressure of 80 bar. The reaction was allowed to proceed for 6 hours. The reaction mass at the end of the reaction had the appearance of dark red slurry, and the viscosity of liquid products was similar to that of methanol, with chunks of fibers settled at the bottom of the reactor, and few lighter chunks floating on liquid surface.

The resulting products from the reaction were filtered using a funnel, separating fibrous residue and catalyst from the liquid products. Fibers were air dried and stored in desiccator, whereas the liquid product was stored in rubber stoppered conical flask. Excess methanol was removed from liquid product, using a rotary evaporator under vacuum, resulting in viscosity of products similar to honey, along with waxy precipitates sticking to the wall of glass vial.

The reaction scheme described above was repeated 15-20 times to produce several batches of products. On the average 3 g of depolymerized products were obtained per 15 grams of straw fibers charged into the reactor (although this mixture including some quantity of methanol), where 15 g of rice straw contains 2.9 grams of lignin. Qualitative and quantitative analysis of the reaction products in underway, using gas chromatography—mass spectrometry and gas chromatography—flame ionization detection.

One interesting observation is that the fibers of the rice straw clumped to form chunks in the reactor, which may result in less than effective mixing. We believe that this mixing issue is due to the small tank size, as well as the tank having a significant number of internal baffles. Investigation of the mixing process of rice fiber with methanol was done in a glass tank at room temperature without catalyst without internals. Observation of the resulting mixture revealed some clumping of the fibers, but the mixture could be readily agitated indicating that as one moves to larger processing equipment there is nothing with respect to the mixing that cannot be addressed using slurry mixing technology that is standard in the chemical industry.

The liquid products of the reaction were dark red in color, precipitates were observed to stick to the glassware after removal of excess methanol; however, no precipitates were observed on the inside of the steel reactor. This indicates that the precipitates are likely silica. In the envisaged composite board application of the depolymerized rice fiber mixture the presence of silica particles poses no significant problem; thus, removal of silica is not considered important at this time.

### Composite Boards Production Using Rice Straw with Lignin from Rice Straw

Materials used in the rice straw fiberboard including a combination of depolymerized rice lignin reactor product, urea, ethylene urea, glyoxal, glutaraldehyde, Polycup™, maleic anhydride, succinic anhydride, potassium hydroxide, and a paraffin wax. POLYCUP is a registered trademark of Solenis Technologies, LP, a Delaware Limited Partnership, 3 Beaver Valley Road, Suite 500, Wilmington, DELAWARE, 19803, reg. no. 0863338. Solvents in the process consist of water and methanol.

The solids content of the liquid phase (i.e. non fiber) from the reactor described above was approximately ⅓ or the total mass. Thus, if rice fiber costs $0.15/kg, then the cost per pound of rice resin is $0.46/kg for the material. Making a very generous assumption that there is $0.02/kg for the capital equipment for a 45M kg/year plant and $0.02/1b for operating costs, the total rice resin cost is $0.53/kg, where using the $0.55 number is overly conservative.

The composite boards were made with 11 wt % of the resin package. The 89% of fibers was composed of ⅓ from the fibers used to produce the rice resin and ⅔ from new rice fibers. Thus, the total cost of materials is:

$$0.11 * \$0 \text{.36} + 0.66 * \$0 \text{.07} = \$0.0 \; 86 lb / composite board$$

This should be compared to the alternative PMDI with rice fiber board

$$7 \% PMDI at \$3 \text{.30} / kg + 93 \% rice fiber at \$0 \text{.15} / kg = \$0 \text{.37} / kg$$

Thus, the total material cost to the board manufacturer using the instant rice resin system is approximately 50% of that of the PMDI formaldehyde-free alternative. Moreover, there is considerable room for optimization, such as, for example, reduction of succinic anhydride, better cost on production of rice resin, efficiencies of scale, and the like.

The process of first making rice straw fiberboard may be envisioned to begins with making a Resin Cure Package (RCP) and then a Wax+Surface Modification Package (WSMP).

### Resin Cure Package

First, solid urea pellets and/or ethylene urea powders are added to a capable vessel. The depolymerized rice lignin product is mixed with methanol solvent to reach 60% “solids” content and this mixture is then added to the vessel and subsequently both glyoxal and glutaraldehyde cross-linkers are added. Then, additional methanol is used to adjust the viscosity of this mixture so as to yield a sprayable mixture, where the amount of methanol added is typically 2-3 ml per ml of the lignin, glyoxal and glutaraldehyde solution. The resulting mixture is subsequently heated in an oven at 85° C. for about five minutes. Then an aqueous solution of maleic anhydride is added to the mixture, followed by the Polycup™ cross-linking agent. Finally, potassium hydroxide is added to bring pH to the neutral condition that is desired for optimal reaction of the Polycup™.

### Wax+Surface Modification Package

The WPSMP is made in a separate vial. First 0.1 g of succinic anhydride is dissolved in 0.3 ml of a 1:5 by mass water-methanol mixture with slight heating to facilitate the dissolution of the succinic anhydride. Paraffin based wax is then added to this mixture. This mixture already is at or near the proper viscosity for spraying.

When manufacturing the board, the first step is to determine the required amount of fiber for the desired density and size of board. The WPSMP is sprayed on the fibers; the wetted fibers are mixed; and the mixture is dried in an oven, for example at 75° C. for ten minutes. Once this mixture is at the optimal moisture content (approximately 10 to 12 wt %) as may be determined by touch, the RCP is sprayed on these fibers; and, the fiber with resin mixture is further agitated to ensure uniform coating of the fibers with the RCP. This RCP-fiber pre-composite is then dried in the oven, for example at 85° C. for two minutes, to remove some additional moisture content so that the pre-composite have appropriate tack (i.e. the ability for fibers and resin to form the appropriate shape for the mold). Ideal conditions for pressing are 10-12% moisture content.

Current procedure for 5×7.6 cm (2×3 inch) boards employs a heated press with the bottom platen at 170° C. and the top platen at 175° C. This temperature differential helps prevent board warping during manufacturing. Aluminum foil with a mold release agent is used to prevent the board from sticking to the press platens. Pressure profile for the first press at 400±25 PSI for 3 minutes and 700±25 PSI for 1 minute. The removal of the board between pressings allows for solvent to leave the system. Once the board is cooled after coming out of the press, the edges are trimmed.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

### Example 3: Methods for the Production of Binder Resin

### Experimental Test Set 1

Thirteen 10 cm by 10 cm (4″×4″) resin-laminated samples were manufactured using (i) pure GP resin, (ii) pure CPL resin and (iii) GP resin extended with either rice eugenol at 25% by weight or surrogate rice eugenol at 25% by weight. All samples were formed at a pressure of 55600 Newtons (12,500 lbs force) in a Carver press. The detailed composition and manufacturing conditions are given in Table 6. After manufacture, all laminates were then visually inspected, dimensions measured, and subjected to the boiling water test for 30 minutes. The results are shown in Table 7.

TABLE 6
Composition in Weight Percent of Solids in Resin and Manufacturing Conditions for Kraft Paper Laminates

| | Type of | | | | | Glutar- | | | Press Time | Press Temp. |
|---|---|---|---|---|---|---|---|---|---|---|
| Sample | Phenolic | Phenolic | Eugenol | Urea | Glyoxal | aldehyde | Polycup | KOH | (min) | (° C.) |
| 1 | GP | 100 | 0 | 0 | 0 | 0 | 0 | 0 | 5.0 | 135 |
| 2 | GP | 100 | 0 | 0 | 0 | 0 | 0 | 0 | 7.0 | 135 |
| 3 | GP | 100 | 0 | 0 | 0 | 0 | 0 | 0 | 9.0 | 135 |
| 4 | GP | 100 | 0 | 0 | 0 | 0 | 0 | 0 | 0.8* | 175 |
| 5 | GP | 100 | 0 | 0 | 0 | 0 | 0 | 0 | 6.5 | 145 |
| 6 | GP | 100 | 0 | 0 | 0 | 0 | 0 | 0 | 7.7 | 145 |
| 7 | CPL | 100 | 0 | 0 | 0 | 0 | 0 | 0 | 5.5 | 145 |
| 8 | Syn | 75 | 9.71 | 1.62 | 10.36 | 0.81 | 0.24 | 2.27 | 5.5 | 147 |
| | 25% | | | | | | | | | |
| 9 | Syn | 75 | 9.71 | 1.62 | 10.36 | 0.81 | 0.24 | 2.27 | 4.5 | 147 |
| | 25% | | | | | | | | | |
| 10 | R-Eug | 75 | 5.06 | 2.12 | 13.49 | 1.06 | 0.32 | 2.95 | 5.5 | 147 |
| | 25% | | | | | | | | | |
| 11 | R-Eug | 75 | 5.06 | 2.12 | 13.49 | 1.06 | 0.32 | 2.95 | 6.5 | 147 |
| | 25% | | | | | | | | | |
| 12 | R-Eug | 75 | 5.06 | 2.12 | 13.49 | 1.06 | 0.32 | 2.95 | 7.5 | 147 |
| | 25% | | | | | | | | | |
| 13 | Syn | 75 | 9.71 | 1.61 | 10.36 | 0.81 | 0.24 | 2.27 | 4.0 | 147 |
| | 25% | | | | | | | | | |

All laminates were composed using 2 layers of Kraft paper

TABLE 7
Dimension, dimensional characteristics and
moisture absorption for all laminates.

| | | | Thick- | Sample | Thick- | |
|---|---|---|---|---|---|---|
| | | Finish | ness | Mass | ness | Moisture |
| Sample | Warp | (Gloss) | (mm) | (g) | Swell % | Absorption % |
| 1 | High | Patchy | 0.717 | 3.118 | 33.5 | 37 |
| 2 | Flat | Good | 0.697 | 3.118 | 28 | 33 |
| 3 | Minor | Low | 0.713 | 3.544 | 23.6 | 24.2 |
| 4 | High | Blister | 0.673 | 2.977 | 18.6 | 27.5 |
| 5 | Minor | Low | 0.663 | 2.693 | 21.7 | 29.6 |
| 6 | Flat | Good | 0.703 | 2.835 | 26.5 | 28.5 |
| 7 | Flat | Good | 0.807 | 3.260 | 16.1 | 28 |
| 8 | Minor | Low | 0.72 | 2.835 | 24 | 37.5 |
| 9 | Flat | Low | 0.745 | 2.835 | 23 | 33 |
| 10 | Flat | Good | 0.72 | 2.693 | 28 | 42 |
| 11 | Minor | Good | 0.71 | 3.118 | 23 | 37 |
| 12 | Flat | Good | 0.693 | 2.835 | 23.5 | 33 |
| 13 | Minor | Dry | 0.723 | 2.693 | 27 | 34 |

GP: Georgia Pacific PF Resin; CPL: Arclin Continuous Press Laminate PF Resin; Syn 25%: 25% Sigma Aldrich Eugenol Resin Extender in 75% GP PF Resin; R-Eug 25%: 25% Rice Straw Derived Eugenol Resin Extender in 75% GP PF Resin; * Indicates Quick Cycle Short Press Time with Higher Temperature

From the results reported in Table 7, it is observed that the optimal pressure and cure time conditions for the various resin systems are:
1. Pure GP resin: force exerted—55600 N (12500 lbs); cure time—7.7 minutes; cure temperature—145° C.
2. Mixture of CPL resin with 25 wt % of surrogate eugenol with cross-linkers from Sigma-Aldrich: force exerted—55600 N (12500 lbs); cure time—4.5 minutes; cure temperature—147° C.
3. Mixture of CPL resin with 25 wt % of rice eugenol with cross-linkers: force exerted—55600 N (12500 lbs); cure time—7.5 minutes; cure temperature—147° C.

The addition of 25 wt. % of the surrogate eugenol to the PF resin increased the thickness swell and moisture absorption. It is noted that the eugenol extended resins produced a lighter color laminate as that compared to the traditional PF resin allow, which is potentially beneficial when used with a lighter-colored upper décor layer. It is promising that no samples exhibited any signs of delamination after the water boil test. It was also noted that the pure Arclin phenol-formaldehyde resin performed better than the pure GP resin, where the GP resin was glossy and tacky most likely because it is a higher pH, resole resin. A different set of cure conditions and/or combination of resin chemistry, pressure, and volatiles amount in resin at B-Stage should improve the performance of the GP resin.

### Experimental Test Set 2

The next samples were 7.5 cm by 20 cm (3 in by 8 in), where the composition is shown in Table 8 These specimens were made to test the Arclin CPL resin as a baseline against the CPL resin extended (i) with depolymerized rice lignin with cross-linkers and (ii) depolymerized wood lignin with cross-linkers. Samples were made in the larger PHI 12×12-inch press. All samples used the same press conditions of 490300 N (50 tons force) at 140° C. for 8.5 minutes to ensure complete cure. The amount of depolymerized rice lignin wood used to extend the CPL resin were increased to 50 wt. %.

TABLE 8
Composition in Weight Percent of Solids in Resin for Laminates in Set 2

| | | | Ethylene | | | Glutar- | | |
|---|---|---|---|---|---|---|---|---|
| Sample | Phenolic | Eugenol | Urea | Urea | Glyoxal | aldehyde | Polycup ™ | KOH |
| CPL Resin Only | 100 | 0 | 0 | 0 | 0 | 0 | 0 | 0 |
| CPL + 50% Rice | 50 | 25.36 | 0 | 3.83 | 16.84 | 1.15 | 0.72 | 2.10 |
| Resin Extension | | | | | | | | |
| CPL + 30% Wood | 70 | 15.22 | 1.27 | 1.27 | 9.92 | 0.64 | 0.29 | 1.40 |
| Resin Extension | | | | | | | | |

All specimens exhibit acceptable visual gloss and no warp. 2.5 cm by 2.5 cm (1×1-in) squares were cut for in house water absorption and thickness swell tests. The results of water absorption and thickness swell for the CPL resins are shown in Table 9, where employing 30 to 50 wt. % eugenol to extend the CPL resin system increased water absorption, although it is possible that the use of various additives (e.g. fatty acids, diethylene glycol, or glycol ethers) can reduce water absorption. Thickness swell values are still within specifications. Once again, the samples showed no signs of delamination.

TABLE 9
Water Absorption and Thickness Swell for 2-Ply CPL-based
Laminate Results After 30-minute Boiling Water Test

| | Water | Thickness |
|---|---|---|
| Sample | Absorption % | Swell % |
| CPL Resin Only | 6 | 4.4 |
| CPL + 50% Rice Resin Extension | 22 | 7.8 |
| CPL + 30% Wood Resin Extension | 17.5 | 6 |

The remainder of the samples tested for both water absorption and blister tests on these samples. Water boil test was conducted for 2 hours compared to the in-house method of 30 minutes. The results are shown in Table 10. The key findings in Table 9 are that the addition of the depolymerized rice/wood lignin resin has a minimal effect on the thickness swell and moisture absorption. In addition, these system with the added rice/wood degraded lignin did not blister after 80 mins in boiling water.

TABLE 10
Water Absorption and Thickness Swell for 2-Ply CPL-based Laminate
Results After 2-hour Boiling Water Test and Blister Test Results

| | Moisture | Thickness | |
|---|---|---|---|
| | Absorption (%) | Swell (%) | Blister (sec) |
| CPL Resin Only | 32.0 | 12.5 | >80 Discoloring/ |
| | | | Burnt |
| CPL + 50% Rice | 41.4 | 11.4 | >80 Discoloring/ |
| Resin Extension | | | Burnt |
| CPL + 30% Wood | 30.8 | 9.1 | >80 Discoloring/ |
| Resin Extension | | | Burnt |
| Commercial Laminate | 10.0 | 11.0 | 38 Blistering |
| System | | | |

### Experimental Test Set 3

The next set of 7.5 cm by 20 cm (3 in×8 in) laminate specimens were manufactured in the press to ensure more consistent and even pressure with approximately 588400 N (60-tons force) at 144° C. for 11 minutes. The composition is given in Table 11. Two samples were 70/30 mixtures of CPL resin with rice eugenol resin. The third sample was a 70/30 mixture of CPL resin with wood eugenol resin.

TABLE 11
Composition in Weight Percent of Solids in Resin for Laminates in Set 3

| | | | Ethylene | | | Glutar- | | |
|---|---|---|---|---|---|---|---|---|
| Sample | Phenolic | Eugenol | Urea | Urea | Glyoxal | aldehyde | Polycup | KOH |
| CPL + Wood Extension | 70 | 16.56 | 0 | 1.31 | 9.99 | 0.66 | 0.30 | 1.18 |
| CPL + Rice Extension (1) | 70 | 17.96 | 1.43 | 0 | 8.55 | 0.86 | 0.64 | 0.57 |
| CPL + Rice Extension (2) | 70 | 13.10 | 1.82 | 0 | 12.13 | 0.61 | 0.27 | 2.06 |

Both samples formed a solid laminate, but some defects were observed. The depolymerized wood lignin extended sample had a minor warp, but had the best surface finish of the two. The depolymerized rice lignin laminates were flat, but exhibited a splotchy color across the laminate indicating that the press conditions require optimization.

2.5 by 20 cm (1×8 in) strips were cut for water boiling tests, where the results are shown in Table 12. The remaining 5×20 cm (2×8-in) samples were used in the radiant heat blister test, performed for 120 seconds on all samples, where all samples passed without any blister. The samples began to char but not burn, which is a preliminary indication of the fire resistance of the laminates. Eugenol is considered a fire retardant; therefore, it is possible that the addition of depolymerized rice lignin (where eugenol is a component) to the phenol-formaldehyde laminating resin aids in fire resistance, where laminates can be sold at a higher margin if they have improved fire resistance capabilities. While our samples passed the NEMA LD3 testing standards, these are part of older US Standards. Samples will have to pass more prevalent ISO Standards as those are what the industry is transitioning to.

TABLE 12
Water Absorption and Thickness Swell for 2-Ply CPL-based Laminate
Results After 2-hour Boiling Water Test and Blister Test Results

| | Water | Thickness | |
|---|---|---|---|
| | Absorption (%) | Swell ( %) | Blister (sec) |
| CPL + Wood | 41.9 | 11.3 | >120 Discoloring/ |
| Extension | | | Burnt |
| CPL + Rice | 41.0 | 11.8 | >120 Discoloring/ |
| Extension (1) | | | Burnt |
| CPL + Rice | 42.5 | 8.6 | >120 Discoloring/ |
| Extension (2) | | | Burnt |

### Experimental Set 4

Four aspects were tested in this set: (1) the interaction of 70/30 mixture of CPL resin with depolymerized lignin resin with what is called a décor paper, (2) the compatibility of the 70/30 mixture of PF resin and the depolymerized lignin cure package with different types of Kraft paper, (3) adding wax to improve water absorption and thickness swell, (4) an attempt to manufacture the laminates similar to industry by using a stacked laminate layup. The two different types of paper impregnated with resin are described below:
a. Two 30 cm by 30 cm (12″×12″) test specimens were produced using a traditional Kraft paper. The mass ratio of glyoxal to the depolymerized rice lignin is shown in Table 11. The manufacturing protocol for these specimens was: (i) B-Stage cure at 138° C. followed by (ii) 588400 N (60 tons pressure) at 140° C. for 24 minutes.
b. Two 15 cm by 20 cm (6″×8″) test specimens were produced using paper made of 50% Bagasse, which is the pulp residue after the extraction of sugar cane juice. Bagasse Sample 2 had more depolymerized rice lignin as shown in Table 11, thereby decreasing glyoxal to rice lignin ratio which decreases the extent of cross-linking. The manufacturing history for Sample 1 was: (i) a B-stage cure at 138° C. (ii) 588400 N (60 tons pressure) at 140° C. for 24 minutes. The manufacturing history for Sample 2 was: (i) a B-stage cure at 132° C. followed by (ii) curing in a hot press with 60 tons of pressure at 140° C. for 24 minutes. The reason for the lower B-stage cure for Sample 2 was an observation made with Sample 1 is that the Bagasse specimens were curing faster than normal, where it was later realized that this is because the pH of the Bagasse material is higher which results in a faster cure.

Due to the higher water absorption and thickness swell results seen in previous experiments, wax was added. Waxes were added to the resin mixture before brushing the resin onto the paper for the B-Stage cure. Waxes tested include (i) an experimental wax from Astro American Chemical Co. designated Emulsion 002 Paraffin and Slack Wax and (ii) Michelman Inc. 66035 High Density Polyethylene Wax. DOSS (dioctyl sulfosuccinate) was added into the resin as well to aid with penetration into the Kraft paper. Michelman Wax was found to mix better with our resin mixture. The resin composition of the three laminates is given in Table 13.

TABLE 13
Composition in Weight Percent of Solids in Resin for Laminates in
Experimental Set 4 for both Kraft Paper and Bagasse Laminates

| | Hood Paper | 1^{st} Bagasse | 2^{nd} Bagasse |
|---|---|---|---|
| | Laminates | Laminate | Laminate |
| CPL Phenolic Resin | 70 | 70 | 70 |
| Depolymerized Rice Lignin | 13.59 | 13.59 | 15 |
| Ethylene Urea | 0.35 | 0.35 | 0.23 |
| Urea | 1.64 | 1.64 | 1.09 |
| Glyoxal | 13.59 | 13.59 | 11.56 |
| Glutaraldheyde | 0.76 | 0.76 | 0.51 |
| Polycup | 0.39 | 0.39 | 0.26 |
| KOH | 0.98 | 0.98 | 0.66 |
| DOSS | 0.09 | 0.09 | 0.06 |
| Astro Wax | 0.56 | 0.56 | 0.38 |
| Michelman | 0.38 | 0.38 | 0.25 |

The core of each laminate sample consisted of two resin impregnated Kraft paper sheets. Above these sheets, a décor paper was placed. The décor print paper used was a typical décor print paper with wood print. Above the décor paper, a clear overlay sheet made of melamine formaldehyde high flow resin mixed with aluminum oxide particles (size 220F) was placed as the top layer of each sample. This overlay is a fast cure overlay and is used in the flooring industry. The primary task of an overlay is as a protective wear layer with a secondary objective of stain resistance. The laminates were manufactured using the standard industry method of stacking multiple laminates within the press. On the top and bottom of each laminate with overlay sheet was a thin sheet of aluminum foil coated with 7991 polyethylene with siloxane mold release. Press pads were used to separate the laminates and the aluminum foil release layer, where the press pads are pieces of plain Kraft paper wrapped in aluminum foil. The detailed arrangement of the stack of materials in the press is given in Table 14.

TABLE 14
Stack of Laminates/DécorPaper/Overlay for Curing in Hot Press

| | |
|---|---|
| Top Press Platen | |
| Stainless Steel 610 Series Press Plate | |
| Aluminum Foil Sheet coated with Mold | |
| Release | |
| Overlay | |
| Décor Paper | |
| Two, 12″ × 12″ B-Stage Cured Hood | |
| Kraft Paper | |
| Aluminum Foil Sheet coated with | |
| Mold Release | |
| Aluminum Foil Kraft Paper Separator | |
| Pad | |
| Aluminum Foil Sheet coated with | |
| Mold Release | |
| Two, 12″ × 12″ B-Stage Cured Hood | |
| Kraft Paper | |
| Décor Paper | |
| Overlay | |
| Aluminum Foil Sheet coated with | |
| Mold Release | |
| Stainless Steel 610 Series Press | |
| Plate | |
| Aluminum Foil Sheet coated with | |
| Mold Release | |
| Overlay | Overlay |
| Décor | Décor |
| Two 6″ × 8″ B-Stage Cured | Two 6″ × 8″ B-Stage Cured |
| Century Kraft | Century Kraft |
| Paper | Paper |
| Aluminum Foil Sheet coated with | |
| Mold Release | |
| Aluminum Foil Kraft Paper | |
| Separator Pad | |
| Bottom Press Platen | |

The laminate assembly detailed in Table 14 was placed in a PHI press under 588400 N (60 tons) (corresponding to 833 psi for the 930 cm² (144 in²) laminate assembly) for 24 mins at 140° C. The manufacturing process did not function fully as intended, where the second hood Kraft paper laminate that was sandwiched in the middle of the layup did not form a laminate. Specifically, the hood Kraft paper laminate delaminated upon removal from the layup, which is likely due to heat transfer limitation to the center of the layup where this hood Kraft paper laminate was located. Notwithstanding the difficulties with the centermost laminate material, we believe the thermal history of the outer laminates was able to cure the resin.

The laminates were tested for water absorption and thickness swell, where the results are shown in Table 15. The added wax added substantially in the reduction of water absorption as compared to data in the previous sets of experiments. The addition of wax had a minimal effect on thickness swell. The values of 15% water absorption and 15% thickness swell are well in line with industry standards. In the boiling water test, only Sample 1 of the Bagasse laminate delaminated, which we ascribe to over-curing during the B-Stage process that was indicated by the color of the B-Stage Kraft paper after the B-Stage cure process. Specifically, over-cured samples look lighter in color and have a golden sheen whereas properly B-Staged Kraft paper still has a darker brown hue.

TABLE 15
Water Absorption and Thickness Swell for 2-Ply CPL-based Laminate
with Wax, Décor Paper, and Overlay. Results After
30-minute Boiling Water Test and Blister Test Results.

| | Water | | |
|---|---|---|---|
| | Absorption | Thickness | Observations After |
| | (%) | Swell (%) | Boil Test |
| Bagasse Century | 13.8 | 15.6 | Fraying on Edge, |
| Laminate with Wax | | | Brittle, Delaminated |
| (Sample 1) | | | |
| Bagasse Century | 6.25 | 9.45 | Less Fraying on Edge, |
| Laminate with Wax | | | Less Brittle |
| (Sample 2) | | | |
| Hood Kraft Paper | 15.8 | 14.3 | No Fraying on Edge, |
| Laminate with Wax | | | Not Brittle |

### Experimental Set 5

Repeats of the previous Kraft paper laminate with wax were conducted to achieve better Water Absorption and Thickness Swell. It was discovered that Michelman's wax mixed better with the resin in the previous Experimental Set 4 and therefore, more was added. The resin composition is shown in Table 16. The B-stage cure temperature for these laminates was 132° C. Press conditions were 588400 N (60 tons) at 124° C. for 24 minutes. Water absorption and thickness swell was measured as reported in Table 17. After manufacturing, the laminates exhibited warp due to the overlay being over-cured, which is probably due to the fact that this overlay is a highly catalyzed, fast cure overlay and therefore not well-suited for use in a static press.

However, the added wax amounts did improve water absorption and thickness swell, yielding results better than the industry standard shown in Table 10.

TABLE 16
Composition in wt % of each component in the resin used
in Experimental Set 5: Kraft Paper Laminates with Wax

| | |
|---|---|
| CPL Phenolic | 70 |
| Rice Eugenol | 14.21 |
| Ethylene Urea | 0.44 |
| Urea | 1.55 |
| Glyoxal | 8.88 |
| Glutaraldehyde | 0.66 |
| Polycup ™ | 3.33 |
| KOH | 1.33 |
| DOSS | 0.44 |
| Michelman Wax | 2.13 |

TABLE 17
Water Absorption and Thickness Swell for 2-Ply CPL-based Laminate
with Wax, Décor Paper, and Overlay. Results After
30-minute Boiling Water Test and Blister Test Results.

| | Water | | Observations |
|---|---|---|---|
| | Absorption | Thickness | After |
| | (%) | Swell ( %) | Boil Test |
| Hood Kraft Paper Laminate, | 5.00 | 10.0 | No Fraying |
| Increased Wax (Sample 1) | | | |
| Hood Kraft Paper Laminate, | 8.97 | 11.2 | No Fraying |
| Increased Wax (Sample 2) | | | |

### Experimental Set 6

An important aspect of manufacturing laminates is the temperature at which samples are cured during the B-Stage cure process. All hood Kraft laminate samples until Experiment Set 6 had used Kraft paper B-Stage cured at 138° C. For this new set of experiments, the Kraft paper cure temperature was increased to 142° C. for Sample 3 and decreased to 132° C. for Sample 4. The composition of the resin system is given in Table 18. The manufacturing conditions in the press were 60 tons of pressure at 126° C. for 24 minutes. The resin composition is as show in Table 16, where the wax was Michelman. A new overlay was used to reduce the amount of warping. It has no aluminum oxide, less catalyst and a sugar plasticizer in the resin. The laminate were cured in the PHI pressure with a pressure of 60 tons at 126° C. for 24 mins.

TABLE 18
Composition in wt % of each component in the resin
used in Experimental Set 6: Kraft Paper Laminates,
two different B-Stage Cure Temperatures

| | |
|---|---|
| CPL Phenolic | 70 |
| Rice Eugenol | 16.18 |
| Ethylene Urea | 0.39 |
| Urea | 1.06 |
| Glyoxal | 7.73 |
| Glutaraldehyde | 0.53 |
| Polycup | 0.53 |
| KOH | 1.13 |
| DOSS | 0.35 |
| Michelman Wax | 2.11 |

Water absorption and thickness swell were measured and are reported in Table 19. When the B-Stage cure was 142° C., a large bubble sandwiched between the Kraft paper plies appeared so that a laminate was not formed; specifically, the higher temperature B-Stage cure resulted in the resin to become over-cured in the B-Stage process which resulted in less flow and adhesion during the final pressing process. When the B-Stage cure was 132° C., the resulting laminate had a blister, indicating excess volatiles in the resin that failed to escape in the B-Stage cure. Thus, temperatures near 138° C. are optimal for the CPL/Depolymerized rice lignin resin mixture. The water absorption and thickness swell for the Sample 4 which was not delaminated are excellent. Finally, the new overlay significantly reduced the amount of warping, which support the hypothesis that the over-cure of the overlay was the source of the warping of the cured panels in Experiment 5.

TABLE 19
Water Absorption and Thickness Swell for 2-Ply CPL-based Laminate
with Wax, Décor Paper, and Overlay. Results After
30-minute Boiling Water Test and Blister Test Results.

| | Water | Thickness | Observations |
|---|---|---|---|
| | Absorption (%) | Swell (%) | After Boil Test |
| Hood Kraft Paper | 25.00 | 13.49 | No Fraying |
| Laminate, 142° C. B- | | | |
| Stage Cure (Sample 3) | | | |
| Hood Kraft Paper | 10.53 | 9.80 | No Fraying, Slight |
| Laminate, 132° C. B- | | | Warping Post Boil |
| Stage Cure (Sample 4) | | | Test |

The investigation detailed above indicates the potential of using depolymerized lignin from rice or corn stover or wood as an extender to reduce the amount of the phenol and formaldehyde in binder resin used in traditional Kraft paper laminates. Two tests for laminating resins are water absorption and thickness swell, where the depolymerized lignin resins were within industry standards when wax was included in the formulation. The majority of the studies replaced 30% by weight of the phenol-formaldehyde resin with depolymerized lignin resin, where there is evidence (from Experimental Set 2) that the depolymerized lignin extended resins may be compatible with PF resins up to a 50/50 mixture. With proper formulation it may be possible to improve the water absorption, thereby potentially reducing even further the amount of phenol and formaldehyde in Kraft paper laminate composites. The next step is to produce larger, 5-ply test specimens so that the specimens can be tested using the full suite of NEMA and ISO Standards in order to prove the commercial viability of this system.

### Alternate Embodiment

A binder system (the glue that holds the composite together) for wood-based composite board products has been developed that uses depolymerized lignin as the major component in the binder system. One attractive feature of this new binder system is that it does not employ formaldehyde, a known carcinogen, where there is significant regulatory pressure to remove formaldehyde from all composite products used in the home. The depolymerized lignin was used just as it comes out of the bioreactor, where both the clean cellulose and majority of the methanol solvent were removed which are easy separation process. However, the remaining reaction mass that contains lignin monomers, residual solvent and sugars was used as received, without any additional purification.

### Preparation of Depolymerized Lignin Feedstock

Depolymerized lignin feedstock was provided. The lignin monomer feedstock was prepared by catalytic depolymerization of poplar wood chips. Specifically, 100 to 200 g of 70 mesh dried wood biomass was reacted under batch conditions with 10% by weight catalyst in 1-2 L methanol solvent under hydrogen pressure (30-50 bar) at 200-225° C. for several hours. Solid filtration followed by solvent concentration under rotary evaporation provided the lignin methoxyphenols feedstock used in resin preparations.

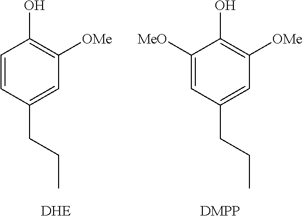

The depolymerized lignin resin was used as received. Specifically, the cellulosic fraction of the wood chips had been removed (except for a limited number of tests) and greater than 95% of the methanol solvent was also removed. However, the remaining reaction mixture was not purified any further. This mixture contains propyl methoxyphenols (see structures above) as the main components, but also includes other minor reaction products including xylose as well as a residual methanol solvent.

One interesting aspect of the binder technology described herein is that it works with the unpurified reaction mixture after the relatively easy removal of the lignin free cellulose solid byproduct and most of the methanol solvent, thereby avoiding the need for costly separation processes. The ability to avoid costly separation operations significantly affects the overall economics of the lignin monomer binder system.

### Production of Binder Resin

Using the depolymerized lignin mixture as the main component in the binder system, a formulated binder system for composite board use was produced. The components in the formulation included:
1. The unpurified depolymerized lignin monomer mixture
2. Polycup™ 9700 curing agent. Polycup™ is a commercial cross-linking resin sold by Solenis and originally developed by Ashland Chemical. Polycup™ is a water soluble polyamide-epichlorohydrin (PAE) resin. As sold, the secondary amine in the polyamide and the epichlorohydrin have reacted to form an azetidnium complex as shown below. Polycup comes in a variety of different grades, where Polycup™ 9700 has an amine enriched polymer with the lowest DCP content and high pH so that it is compatible with both the extractables in the lignin reaction mixture and the various cross linkers.

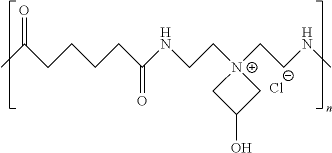

3. Fiber. Different types of wood fiber are used for different applications, herein hard-wood and soft-wood fiber from mixed elm, oak, ash, hickory, maple, chestnut, birch, and poplar, and low amount of soft wood such as spruce, pine and hemlock were used. These woods are typically used in the production of medium density fiber (MDF) boards. Characteristics of the fiber product are: soft, fibrillated fluffy texture with a refined, short fibers with 10% moisture.

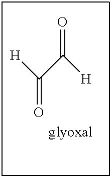

4. Glyoxal. Glyoxal is a small molecule organic compound that is used in the wood/paper industries to crosslink cellulosic material in wood/paper products.
5. Wax. Two different types of paraffin-based waxes were used. Chlorez 700 is a powdered solid paraffin-based wax that is 70% chlorinated, that imparts both water repellency as well as some flame retardancy. During manufacture Chlorez will off-gas HCl which might play a role in the reaction of the Polycup with the lignin monomer. Also used was ULTRALUBE E345. ULTRALUBE is a registered trademark of Keim-Additec GmbH, a Federal Republic of Germany corporation, Hugo-Wagner-Strasse D-55481, Kirchberg, Germany, reg. No. 2389258. ULTRALUBE E345 is a paraffin wax used for water repellency that is an emulsion with 45% solids content. The molecular weight of Chlorez is approximately 350 g/mole; the molecular weight of ULTRALUBE is between 280 to 420 g/mole.

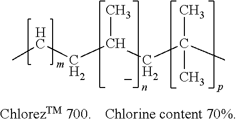

6. Styrene-Maleic Anhydride (SMA). SMA is a random copolymer produced from a monomer mixture of styrene and maleic anhydride. SMA is traditionally used in the wood/paper industries as a dispersant for the paraffinic wax and to aid in better wetting of the wood fibers. The molecular weight is 3500 g/mole.

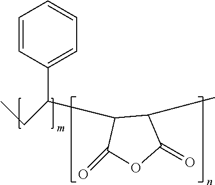

SMA resin. Styrene content 40 mole % and
maleic anhydride content 60 mole %.

The components above make the main mixture used in the binder resin formulation; however, other types of curing agents, additives, and the like have also been investigated. Other compounds that have been studied include:
7. Azideine is a potential alternative crosslinker to the Polycup™.
8. Cyanuric is a potential alternative crosslinker to the Polycup™.
9. Carbodimide is a potential alternative crosslinker to the Polycup™.
10. An aminosilane, specifically gamma-aminopropyltriethoxysilane, which is a potential alternative crosslinker to the Polycup™.

The 10 components above were investigated to determine which components could provide an alternative to the current formaldehyde based thermoset resins. In addition, a traditional phenol-formaldehyde resin system was investigated, which will serve as the target material with which to compare the properties of alternative binder systems.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

1. A method of recovering lignin from biomass, comprising:
(a) soaking a quantity of biomass in an organic solvent to yield a first product;
(b) superheating the first product under elevated pressure;
(c) rapidly reducing the pressure on the superheated first product;
(d) explosively separating lignin from residual cellulosic material to yield separated lignin and residual cellulosic material;
(e) depolymerizing the separated lignin; and
(f) segregating the depolymerized lignin.

2. The method of recovering lignin from biomass of claim 1 and further comprising:
after d) and before e), capturing evolved organic solvent for reuse.

3. The method of claim 1 wherein step e) further comprises exposing the separated lignin to a catalyst-free hydrogen environment under elevated temperature and pressure.

4. The method of claim 1 wherein step f) further comprises separating depolymerized lignin from sugars and hemi-cellulose, and wherein the sugars and hemi-cellulose are harvested for later use.

5. The method of claim 1, further comprising:
(g)
(h) mixing the quantity of depolymerized lignin with predetermined quantities of fiber, curing agent, paraffin wax, glyoxal, and dispersant to define a second admixture; and
(i) bonding the second admixture with cardboard to yield a composite board.

6. The method of claim 5 wherein during h), the second admixture is hot pressed at about 192 degrees Fahrenheit into the cardboard.

7. (canceled)

8. (canceled)

9. (canceled)

10. The method of claim 5 wherein during g),
cellulose is added to the second admixture;
the curing agent is selected from the group consisting of Polycup™ 9700, azideine, cyanuric acid, carbodiimide, gamma-aminopropyltriethoxysilane, and combinations thereof;
the paraffin is selected from the group consisting of seventy percent chlorinated alkane, anionic water-based paraffin wax emulsion with a solid content of about forty-five percent, polyethylene wax, and combinations thereof; and
the dispersant is styrene-maleic anhydride.

11. The method of claim 5 wherein the composite board is formaldehyde-free.

12. The method of claim 11 wherein the composite board exhibits no more than four percent swelling upon exposure to water; wherein the composite board has a modulus of at least 30 kpsia; wherein the composite board has a tensile strength of at least 70 psia; and wherein the composite board returns to its original thickness after forty-eight hours of drying following a twenty-four hour immersion in water.

13. A formaldehyde-free fiber-based composite board comprising:
a fiber portion with a weight percentage of 80-95%; and
a resin portion with a weight percentage of 5-20%;
wherein the resin portion further comprises a resin cure package, and a wax-based surface modification package,
wherein the resin cure package comprises a mixture of a catalytically depolymerized product of a fiber-based lignin, wherein the catalytically depolymerized product comprises at least one compound selected from the group consisting of: 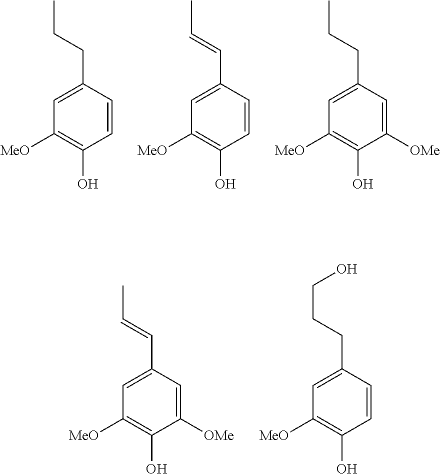
wherein the wax-based surface modification package comprises at least one wax material with a formula of CₙH₂ₙ₊₂, wherein n is 15-40.

14. The formaldehyde-free, fiber-based composite board of claim 13, wherein the fiber comprises rice-straw-based fiber.

15. The formaldehyde-free fiber-based composite board of claim 13, wherein the mixture of the resin cure package further comprises at least one dialdehyde with a formula of OHC(CH₂)ₙCHO, wherein n is 0-6.

16. The formaldehyde-free fiber-based composite board of claim 13, wherein the mixture of the resin cure package further comprises an anhydride.

17. The formaldehyde-free fiber-based composite board of claim 16, wherein anhydride is maleic anhydride.

18. The formaldehyde-free fiber-based composite board of claim 13, wherein the mixture of the resin cure package further comprises a polyamide-epichlorohydrin as a cross-linking agent.

19. The formaldehyde-free fiber-based composite board of claim 13, wherein the mixture of the resin cure package has a pH value of 6.5-7.5.

20. (canceled)

21. (canceled)

22. A method of reducing phenol-formaldehyde in a resin, comprising:
(a) extracting eugenol from a biomass source;
(b) mixing the extracted eugenol with a first quantity of curing agent and a second quantity of water and a third quantity of MeOH solvent in the presence of a KOH catalyst to yield a first admixture;
(c) heating the first admixture to yield a precook admixture;
(d) adding urea and a cross-linking agent to the precook admixture;
(e) adding additional KOH to the precook admixture to yield a second admixture; and
(f) heating the second admixture to yield a resin product;
wherein the resin product has replaced at least about a third of the phenol-formaldehyde with eugenol-based resin;
wherein the biomass is selected from the group comprising rice straw, wood fiber, and combinations thereof;
wherein the curing agent is selected from the group consisting of glutaraldehyde, glyoxal, and combinations thereof; and
wherein the cross-linking agent is a water-soluble poly(amide epichlorohydrin).

23. (canceled)

24. (canceled)

25. (canceled)

26. (canceled)

27. The method of claim 22 and further comprising:
(g) brushing resin product onto respective sheets of paper to yield respective sheets of impregnated paper;
(h) drying the respective sheets of impregnated paper to yield respective sheets of dried impregnated paper;
(i) stacking respective sheets of dried impregnated paper to yield a multiple-sheet laminate stack; and
(j) hot-pressing the multiple-sheet laminate stack to yield a cured multiple-sheet laminate.

28. (canceled)

29. (canceled)

30. (canceled)

31. (canceled)

32. (canceled)
